(19) United States
(12) Patent Application Publication
(10) Pub. No.: US 2009/0019383 A1
(43) Pub. Date: Jan. 15, 2009

(54) USER INTERFACE FOR A PERSONAL INFORMATION MANAGER

(75) Inventors: Clark N. Riley, Chicago, IL (US); Clark A. Riley, Chicago, IL (US)

Correspondence Address: BELL, BOYD & LLOYD, LLP, P.O. Box 1135, CHICAGO, IL, 60690, US

(73) Assignee: WORKSTONE LLC, Chicago, IL (US)

(21) Appl. No.: 12/102,456

(22) Filed: Apr. 14, 2008

Related U.S. Application Data
(60) Provisional application No. 60/911,761, filed on Apr. 13, 2007.

(51) Int. Cl. G06F 3/048

(52) U.S. Cl. 715/764

(57) ABSTRACT

A user interface for a personal information manager is disclosed. The user interface disclosed allows an information worker to set up, manage, and use different views of different user modules. The user interface also combines personal and business data from a plurality of different systems in a manner that allows information workers to use a single consistent interface to access, organize, and modify business information such as contacts, tasks, files, etc.

### PRIORITY CLAIM

This application claims the benefit of U.S. Provisional Patent Application No. 60/911,761, filed Apr. 13, 2007, entitled “User Interface for a Personal Information Manager,” the entire contents of which are hereby incorporated by reference.

### TECHNICAL FIELD

The present system relates in general to computerized organizers, and, more specially to a user interface for a personal information manager.

### BACKGROUND

Personal information managers (computer-based systems commonly known as “personal organizers”) are used widely by business and home users. A typical personal information manager provides the user with a calendar, a contact list, and an e-mail client. Some personal information managers also offer features such as “to-do” lists (also known as “task lists”), journaling features, and “sticky-note” features. Some personal information managers offer messaging features in addition to e-mail, such as instant messaging capabilities and integrated access to threaded discussion boards. Additionally, some personal information managers include collaboration-management features, such as calendar sharing and routed meeting invitations. In addition to such organizer features, some personal information managers also provide a degree of integration with other types of applications; for instance, a personal organizer may allow the user to click on a contact record to find out if that person is online and available for “chatting” in a separate instant messaging application.

Despite the range of available features, personal information managers are currently limited with respect to their ease of use. Given the limitations of current personal information managers, users would benefit from a more efficient way to access and manage personally-relevant information, including both enterprise business information and private personal information. Users would also benefit from tools that would enable them to use their information more effectively; such tools would lead to improved communication and improved decision-making.

Regarding the general constitution of enterprise systems themselves, enterprise systems currently tend to be relatively isolated and rigid; they are oriented toward serving the enterprise as a whole and typically offer no personal workspace for people to store personal and/or private data or to organize enterprise information in terms of the individual's needs and preferences. Furthermore, enterprise systems tend to offer complicated interfaces and the use of enterprise systems is generally regulated according to strict policies and/or procedures. An enterprise system is generally designed for a department or designed to support a business process for the enterprise as a whole; they are generally not designed around the needs and preferences and work-styles of individual users. Furthermore, current enterprise applications are generally limited in terms of their ability to integrate and/or communicate with personal information managers.

### SUMMARY

The present system overcomes the described deficiencies of the prior art by providing a computer system as follows: (a) the system includes a personal information manager; (b) the system also includes a set of other applications and components, optionally including a collection of enterprise applications, as well as other types of data-management, productivity, collaboration, and messaging applications; (c) the personal information manager and the other “native” applications function together by design as a fully-integrated whole, communicating seamlessly and providing complimentary feature sets; (d) the system is also designed to support dynamic connections to external systems, including but not limited to enterprise systems and web services; (e) the system is designed to gracefully accommodate information from virtually any kind of external system; (f) the system is designed to be highly-extensible and includes an application programming interface and related developer tools that support the development of additional related applications that will function as fully-integrated parts of the system.

Additional features and advantages are described herein, and will be apparent from, the following Detailed Description and the figures.

### BRIEF DESCRIPTION OF THE FIGURES

FIG. 1 shows an example of a typical layout of the main sections of the GUI.

FIG. 2 shows an example of the typical layout of panels presented in the module navigation section.

FIG. 3 shows a more detailed example of typical designs of panels presented in the module navigation section.

FIG. 4 shows an example of the GUI in normal viewing mode.

FIG. 5 shows an example of the GUI in split viewing mode.

FIG. 6 shows a detailed view of an example of the module view setup panel.

FIG. 7 shows an example of a typical panel layout of the module display section when the normal viewing mode is in effect.

FIG. 8 shows an example of a typical panel layout of the module display section when the split viewing mode is in effect.

FIG. 9 shows a typical layout of subordinate panels and other features on the module display panel.

FIG. 10 shows a more detailed illustration of the module display panel illustrated in FIG. 9.

FIG. 11 shows another typical layout of the module display panel.

FIG. 12 shows a more detailed illustration of the module display panel as illustrated in FIG. 11.

FIG. 13 shows an example of the module view setup panel.

FIG. 14 shows an example of the module view setup panel indicating that the left selecting mode is in effect.

FIG. 15 shows an example of the module view setup panel indicating that the right selecting mode is in effect.

FIG. 16 shows an example of the GUI displaying a module called “Module A” in the normal viewing mode with the normal selecting mode in effect.

FIG. 17 shows an example of the result when the user starts with the view illustrated in FIG. 16 and then clicks a module selection button labeled “Module B”.

FIG. 18 shows an example of the result when the user starts with the view illustrated in FIG. 17 and then clicks the split view button.

FIG. 19 shows an example of the result when the user starts with the view illustrated in FIG. 18 and then clicks a module selection button labeled “Module D”.

FIG. 20 shows an example of the result when the user starts with the view illustrated in FIG. 19 and then clicks the select left button.

FIG. 21 shows an example of the result when the user starts with the view illustrated in FIG. 20 and then clicks a module selection button labeled “Module F”.

FIG. 22 shows an example of the result when the user starts with the view illustrated in FIG. 21 and then clicks the normal view button.

FIG. 23 shows an example of the result when the user starts with the view illustrated in FIG. 22 and then clicks the select left button.

FIG. 24 shows an example of the result when the user starts with the view illustrated in FIG. 23 and then clicks a module selection button labeled “Module C”.

FIG. 25 shows an example of the result when the user starts with the view illustrated in FIG. 24 and then clicks the normal view button.

FIG. 26 shows an example of the result when the user starts with the view illustrated in FIG. 25 and then clicks the select right button.

FIG. 27 shows an example of the result when the user starts with the view illustrated in FIG. 26 and then clicks a module selection button labeled “Module G”.

FIG. 28 shows an example of the module view setup menu in a typical configuration of the GUI.

FIG. 29 shows an example of “close” buttons added to module display panels in split viewing mode.

FIG. 30 shows an example of a GUI feature that provides the user with a contextual menu for a module selection button.

FIG. 31 shows a more “realistic” example of the navigation section in a typical implementation of the GUI.

FIG. 32 shows an example of the module selection panel being used to present status indicators to the user.

FIG. 33 shows an example of a list display.

FIG. 34 shows an example of a typical result when the user starts with the view illustrated in FIG. 33 and clicks a column header.

FIG. 35 shows an example of a typical result when the user starts with the view illustrated in FIG. 34 and clicks a column header.

FIG. 36 shows an example of a typical result when the user starts with the view illustrated in FIG. 35 and clicks a column header.

FIG. 37 shows an example of a typical result when the user starts with the view illustrated in FIG. 36 and clicks a column header.

FIG. 38 shows an example of an explorer view displaying organizer data.

FIG. 39 shows an illustration of an explorer view displaying organizer information.

FIG. 40 shows an example of a possible result when the user starts with the view illustrated in FIG. 39 and clicks on a data element.

FIG. 41 shows an example of a possible result when the user starts with the view illustrated in FIG. 40 and clicks on a data element.

FIG. 42 shows an example of a second possible result when the user starts with the view illustrated in FIG. 40 and clicks on a data element.

FIG. 43 shows an example of a second possible result when the user starts with the view illustrated in FIG. 39 and clicks on a data element.

FIG. 44 shows an example of a possible result when the user starts with the view illustrated in FIG. 43 and clicks on a data element.

FIG. 45 shows an example of a typical Project Details view of an example Project record.

FIG. 46 shows an example of an Item Classes table used as part of a possible implementation of relationship types in the system.

FIG. 47 shows an example of a Companies table used as part of a possible implementation of relationship types in the system.

FIG. 48 shows an example of a People table used as part of a possible implementation of relationship types in the system.

FIG. 49 shows an example of a Projects table used as part of a possible implementation of relationship types in the system.

FIG. 50 shows an example of a Link Types table used as part of a possible implementation of relationship types in the system.

FIG. 51 shows an example of a Relationship Types table used as part of a possible implementation of relationship types in the system.

FIG. 52 shows an example of an Item Links table used as part of a possible implementation of relationship types in the system.

FIG. 53 shows an example of a possible alternate layout for the Project Details view illustrated in FIG. 45.

FIG. 54 shows an example of a second possible alternate layout for the Project Details view illustrated in FIG. 45.

FIG. 55 shows an example of a third possible alternate layout for the Project Details view illustrated in FIG. 45.

FIG. 56 shows an example of a fourth possible alternate layout for the Project Details view illustrated in FIG. 45.

FIG. 57 shows an example of a possible explorer view displaying the information illustrated in FIG. 45.

FIG. 58 shows an example of a possible “drop-zone layout” for the Project Details view illustrated in FIG. 45.

FIG. 59 shows an example of a Project Details view that allows the user to create linked records and assign relationship types at the same time.

FIG. 60 shows an example of a UML-style class diagram illustrating the conceptual data model (or conceptual “domain model”) for a typical configuration of the system.

FIG. 61 shows an example of part of the data model of a typical configuration of the system.

FIG. 62 shows a UML-style object diagram illustrating the relationships between some of the example records represented in FIG. 45.

FIG. 63 shows another UML-style object diagram illustrating the relationships between some of the example records represented in FIG. 45.

FIG. 64 shows an example screenshot of a typical system that has been configured with four typical project types.

FIG. 65 shows an example of a typical Project Details view of a project item of the project type “Generic Project”.

FIG. 66 shows an example of a typical Project Details view of a project item of the project type “Client Project”.

FIG. 67 shows an example of a typical Project Details view of the Client Project record illustrated in FIG. 66 with an additional relationship type configured for and applicable to the item.

FIG. 68 shows an example of a typical Project Details view of the example project record illustrated in FIG. 67.

FIG. 69 shows an example of a typical Project Details view of the example Project record illustrated in FIG. 68.

### DETAILED DESCRIPTION

This document describes features and benefits of the graphical user interface (GUI) of the Tekton Organizer software application, with special attention given to features for setting up, managing, and using views of user modules. This document also describes features and benefits related to the implementation of relationship types in the Tekton Organizer and in the Tekton System more generally.

The Tekton Organizer is a personal information manager, or “personal organizer” application, that provides the user with data-management, productivity and communication features for business and personal use. The Tekton Organizer is a database-oriented application that manages multiple lists of data and enables the user to create and manage links between the records on those lists, including between records on the same list and between records on different lists. The Tekton Organizer provides a variety of features for viewing and managing data, including features that allow the user to set up and manage different views of organizer data.

The features of the Tekton Organizer are generally presented to the user in modules, including organizer modules and system modules. Each module typically contains one or more lists of data that the user can view and manage.

The organizer modules generally manage personal-organizer data, such as calendar data, contact information, e-mail items, and other information related to the user's relationships and activities. Each organizer module generally focuses on managing a specific class of organizer records; that class is known as the primary class for that module. Examples of typical primary classes of organizer modules include an Activity class (for managing calendar items), a Person class (for managing “contacts”), and an Email class (for managing e-mail items). Each organizer module is generally named according to its primary class.

A typical configuration of the Tekton Organizer includes organizer modules with names such as: Companies, People, Projects, Activities, Locations, Equipment, Folders, Files, E-mail, etc.

The system modules generally manage and display useful information about the organizer itself, such as its overall contents, its history of use, and its specific configuration.

A typical configuration of the Tekton Organizer includes system modules such as: Home (provides the user with a summary page that shows an overview of current organizer data); Updates (allows the user to manage the features that synchronize the organizer with remote data sources); Alerts (provides an overview and history of status alerts from the organizer modules); History (displays information about the user's navigation history and about the modification history of organizer records); Settings (displays system-configuration data and allows the user to manage personal preferences for the system); etc.

The following sections describe the general layout of the graphical user interface (GUI) design. The organizer is designed to be “highly relational” in its data-management capabilities; it is also designed to provide the user with an intuitive and consistent set of tools for using those capabilities. To provide an intuitive and consistent user experience, the GUI employs a consistent set of graphical design elements (such as views, layouts, display formats, icons, controls, and other visual elements) for: displaying different types of information; showing the relationships between pieces of information; managing that information; managing views of the information; and managing the system generally.

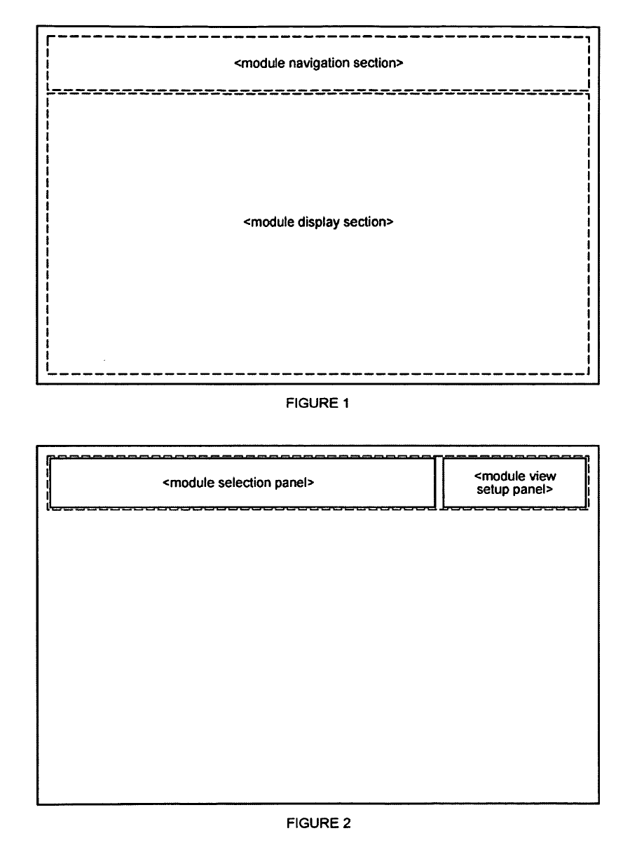

FIG. 1 shows an example of a typical layout of the main sections of the GUI, which generally include a module navigation section and a module display section. (The GUI may include other main sections in addition to those described here.)

The module navigation section generally provides control features that allow the user to select which module or modules will be displayed at any given time.

The module display section generally displays the selected module or modules.

FIG. 2 shows an example of the typical layout of panels presented in the module navigation section, which include a module selection panel and a module view setup panel. (The module navigation section may present other panels in addition to those described here.)

Together, the module selection panel and the module view setup panel generally allow the user to set up and manage different views of the modules, which are displayed in the module display section (the lower part of the screen).

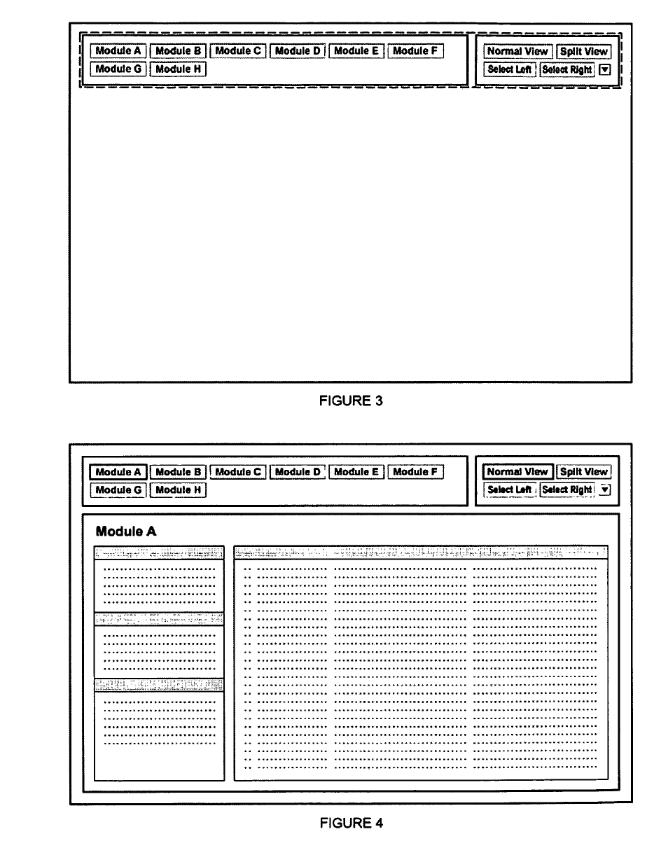

FIG. 3 shows a more detailed example of typical designs for the module selection panel (left panel) and the module view setup panel (right panel).

The module selection panel (left panel) provides a module selection button for each module in the given configuration of the system. FIG. 3 shows an example in which the system is configured with eight modules, generically named “Module A” through “Module H”. The module selection buttons generally allow the user to select modules for viewing.

The module view setup panel (right panel) provides four buttons and a pull-down menu. As shown in FIG. 3, the buttons on the module view setup panel are labeled “Normal View”, “Split View”, “Select Left”, and “Select Right”. The buttons are correspondingly named the normal view button, the split view button, the select left button, and the select right button. In a given configuration of the system, the buttons may be labeled differently or may be presented as graphical icons, but their names and functions will generally remain as described herein. As shown in FIG. 3, the pull-down menu is displayed as a smaller menu button with a downward-facing triangle. The pull-down menu is called the module view setup menu. Clicking the pull-down menu button generally reveals the pull-down menu. The module view setup panel generally provides the same set of features in any configuration of the system.

The following sections describe two modes that are generally implemented by the GUI.

Many aspects of the appearance and behavior of the GUI are governed by two separate but related sets of modes: viewing modes and selecting modes. That is, at any given time, the system will be in one viewing mode and the system will also be in one selecting mode. The module view setup panel is generally used to select the current viewing mode and the current selecting mode, although the module view setup panel does provide other features. Also, the system does provide features elsewhere for controlling the viewing mode and selecting mode (i.e. in addition to those provided by the module view setup panel).

The GUI generally supports two mutually-exclusive viewing modes: the normal viewing mode and the split viewing mode. That is, at any given time, either the normal viewing mode or the split viewing mode will be in effect as the current viewing mode. The current viewing mode generally determines how many modules are displayed in the module display section at a given time. In the normal viewing mode, the module display section generally displays one module view at a time. In the split viewing mode, the module display section generally displays two module views at a time. (The phrase “two module views” is used here rather than “two modules” because a split view may be used to show two different views of the same module.)

FIG. 4 shows an example of the GUI in normal viewing mode.

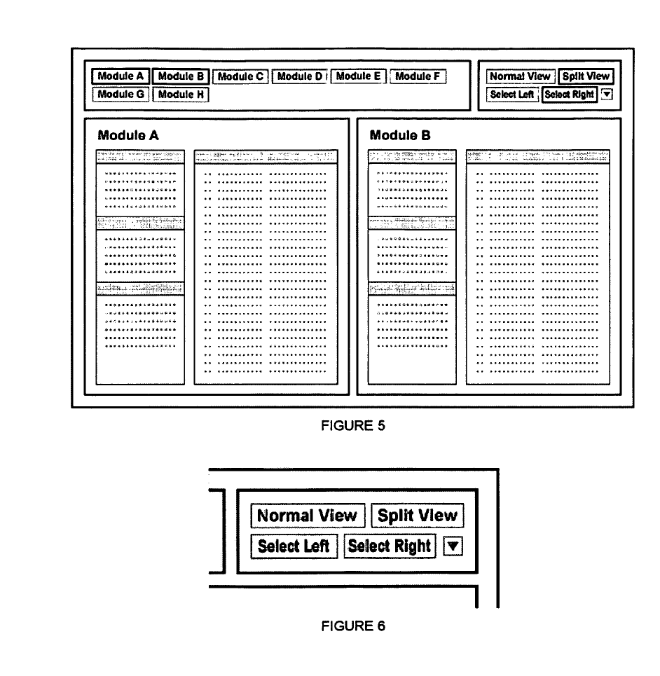

FIG. 5 shows an example of the GUI in split viewing mode.

FIG. 6 shows a detailed view of an example of the module view setup panel.

In FIG. 6, the normal view button is labeled “Normal View”, and the split view button is labeled “Split View”.

On the module view setup panel, the normal view button and the split view button generally allow the user to select viewing modes. Clicking the normal view button generally causes the GUI to enter normal viewing mode. Clicking the split view button generally causes the GUI to enter split viewing mode. The GUI generally provides other features for selecting viewing modes as well.

The user generally interacts with modules through module display panels that are presented in the module display section. A module display panel generally consists of a rectangular area that shows: data from the selected module (i.e. lists and individual records and files), related data from other modules (displayed within the context of the presently-selected module), and graphical control features such as menus and buttons that allow the user to work with the data.

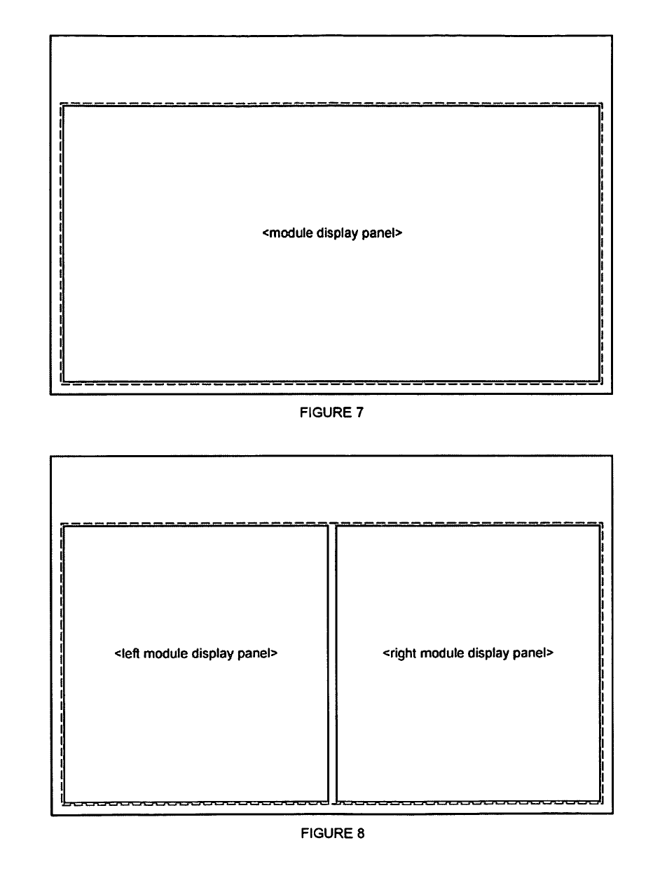

FIG. 7 shows an example of a typical panel layout of the module display section when the normal viewing mode is in effect. When the normal viewing mode is in effect, the module display section generally presents one module display panel, which is called the module display panel.

FIG. 8 shows an example of a typical panel layout of the module display section when the split viewing mode is in effect. When the split viewing mode is in effect, the module display section generally presents two module display panels. When the module display section shows two module display panels, the module display panels are called the left module display panel and the right module display panel. Each module display panel generally shows a view of one module at a time. The left module display panel and right module display panel may show two separate views of the same module or views of two different modules.

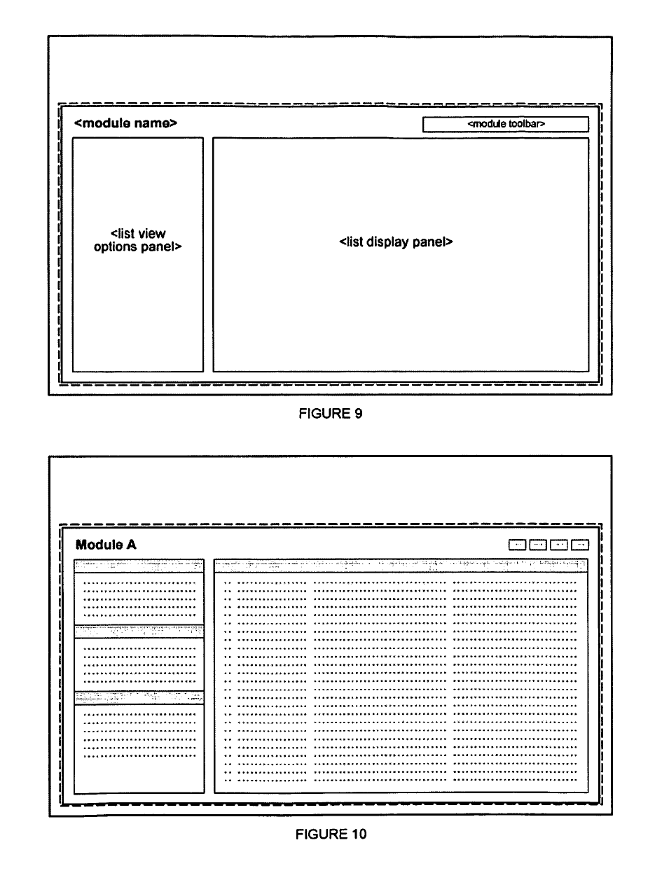

FIG. 9 shows a typical layout of subordinate panels and other features on the module display panel. As shown in FIG. 9, the module display panel generally: displays the name of the selected module; provides a module toolbar with buttons and menus for working with the module; presents a list view options panel; and presents a list display panel. The module display panel also typically provides additional features that are illustrated in subsequent figures.

The list view options panel generally allows the user to select a list in the displayed module (if the module contains more than one list) and generally allows the user to select various options for viewing the list, such as filtering the list, searching the list, formatting the list, etc. The list view options panel can provide multiple sections of options to the user.

The list display panel generally displays the selected list and provides a variety of embedded control features, such as “click-to-sort” column headers, list-line buttons for selecting and modifying list items, and list items that support drag-and-drop features.

FIG. 10 shows a more detailed illustration of the module display panel illustrated in FIG. 9.

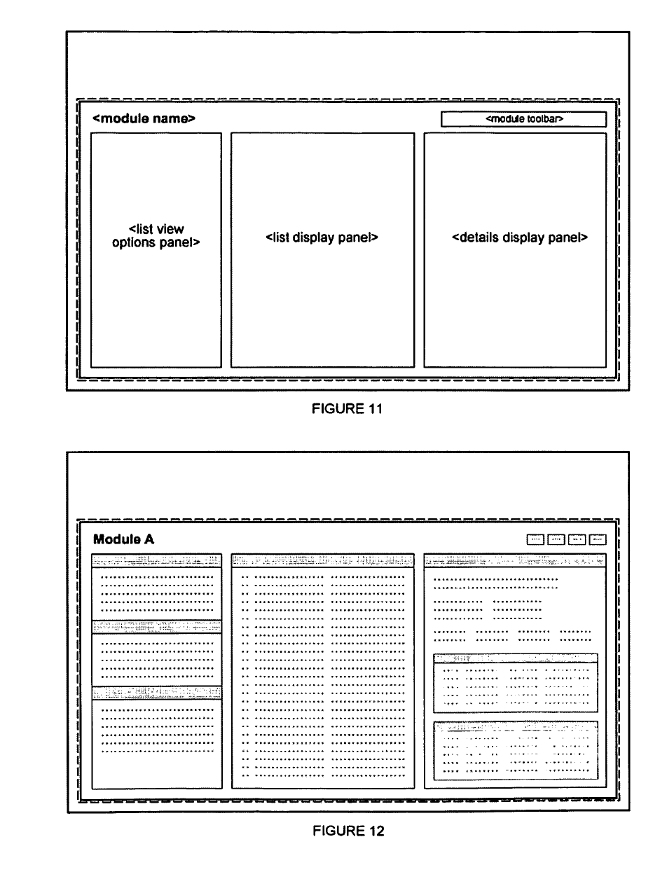

FIG. 11 shows another typical layout of the module display panel. As shown in FIG. 11, the display panel presents an additional subordinate panel called the details display panel. The details display panel generally appears when the user selects an item in the list displayed on the list display panel. The details display panel generally displays the details of the selected item, which is often a database record. In some cases, the item selected from the list may be a file (such as a word-processor document, a picture file, a video file, etc.), an e-mail, a hyperlink to a webpage, or another such item; in such cases, the details display panel may display the corresponding file, e-mail, webpage, or other item. Also, when the details display panel shows a database record, the details display panel may show one or more inset lists of related records from other lists, other modules and/or other data sources. When the details display panel shows an inset list, the details display panel will generally provide a set of control features for interacting with the inset list.

FIG. 12 shows a more detailed illustration of the module display panel as illustrated in FIG. 11.

The subordinate panels displayed in the module display panel generally support user-controlled resizing (typically by dragging the panel boundaries/separators) and/or automatic resizing. Also, many of the panels generally allow the user to collapse and un-collapse the panels; in some cases, a panel may collapse and/or un-collapse automatically in response to particular events; for example, the list options panel may automatically collapse when the GUI switches from normal viewing mode to split viewing mode; the GUI may provide user preference settings that allow the user to control such automatic features.

In some cases, a module display panel may display more than three major sub-panels. For example, when the user selects an item from an inset list in the details display panel, an additional details panel may appear and display details of the selected item. Alternatively, selecting an item in an inset list may cause the GUI to switch to a corresponding split view, showing the details of the selected item in a details display panel on a module display panel that shows the selected items “own” module.

When the split viewing mode is in effect, the left module display panel and the right module display panel generally present the same general layouts and features that the module display panel presents in the normal viewing mode (only narrower).

Note: While this document describes features for managing one- and two-module views, it should be understood that the features described herein can be expanded and repeated as necessary to support views of any larger number of modules at once, for instance, for managing three- or four-panel split views. Furthermore, although the present description illustrates these features within the context of a personal organizer application, it should be understood that these features can be usefully implemented in any typical database-oriented application and in many other types of data-management systems, especially in systems where the user manages two or more related lists of information.

The GUI generally supports three mutually-exclusive selecting modes: the normal selecting mode, the left selecting mode, and the right selecting mode. That is, at any given time, either the normal selecting mode, the left selecting mode, or the right selecting mode will be in effect as the current selecting mode.

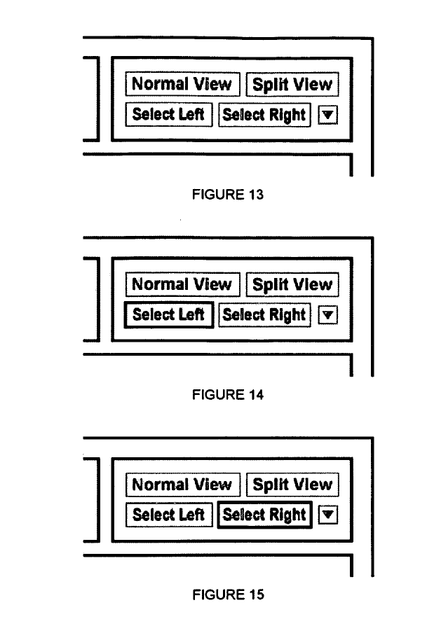

FIG. 13 shows an example of the module view setup panel.

In FIG. 13, the select left button is labeled “Select Left”, and the select right button is labeled “Select Right”.

On the module view setup panel, the select left button and the select right button generally allow the user to select selecting modes. Clicking the select left button generally causes the GUI to enter left selecting mode. Clicking the select right button generally causes the GUI to enter right selecting mode. Entering normal viewing mode generally causes the GUI to enter normal selecting mode. The GUI generally provides other features for selecting selecting modes as well.

The current selecting mode is generally indicated on the module view setup panel.

FIG. 14 shows an example of the module view setup panel indicating that the left selecting mode is in effect.

FIG. 15 shows an example of the module view setup panel indicating that the right selecting mode is in effect.

The normal selecting mode is generally indicated implicitly by indicating neither the left selecting mode nor the right selecting mode. That is, if neither the left selecting mode nor the right selecting mode is indicated (for instance, as in FIG. 13), then the user should understand that the normal selecting mode is in effect.

The current selecting mode generally determines where a newly-selected module will be displayed. When the normal selecting mode is in effect and the user selects a module, the module will generally be displayed in the normal viewing mode (i.e. alone). When the left selecting mode is in effect and the user selects a module, the module will generally be displayed on the left side of a split view. When the right selecting mode is in effect and the user selects a module, the module will generally be displayed on the right side of a split view.

The current selecting mode also generally determines which, if any, currently-displayed module will continue to be displayed after switching from one viewing mode to the other and may determine where that module will be displayed after switching from normal viewing mode to split viewing mode. The effects of the selecting mode are illustrated in the following examples.

The following sections describe examples of uses of the GUI in a typical implementation.

The following-described figures illustrate the effects of selecting modules in different combinations of viewing modes and selecting modes.

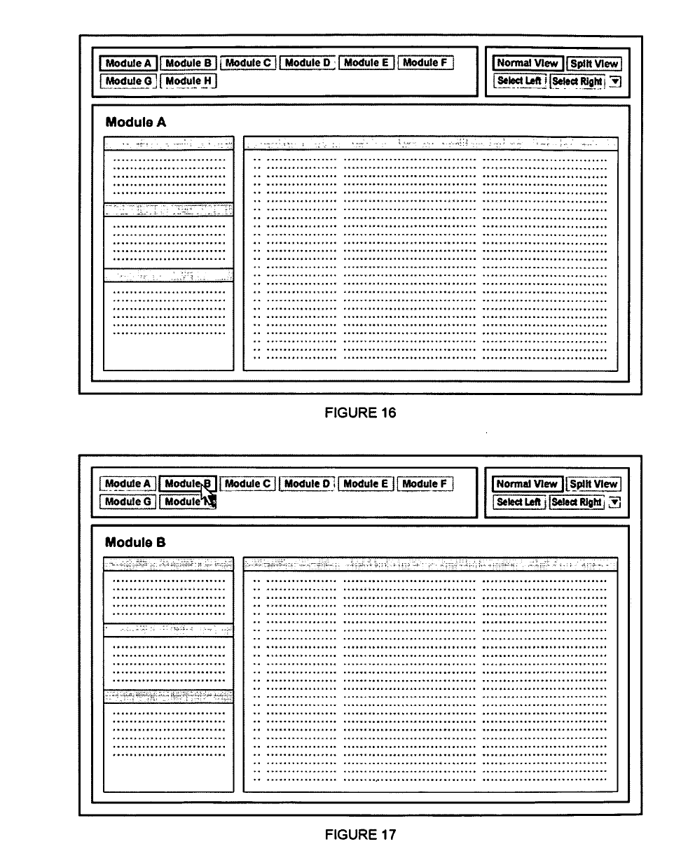

FIG. 16 shows an example of the GUI displaying a module called “Module A” in the normal viewing mode with the normal selecting mode in effect.

FIG. 17 shows an example of the result when the user starts with the view illustrated in FIG. 16 and then clicks a module selection button labeled “Module B”.

Because the normal selecting mode was in effect when the event occurred, clicking the “Module B” button resulted in the GUI displaying Module B in a normal view.

The normal selecting mode remains in effect after the illustrated event.

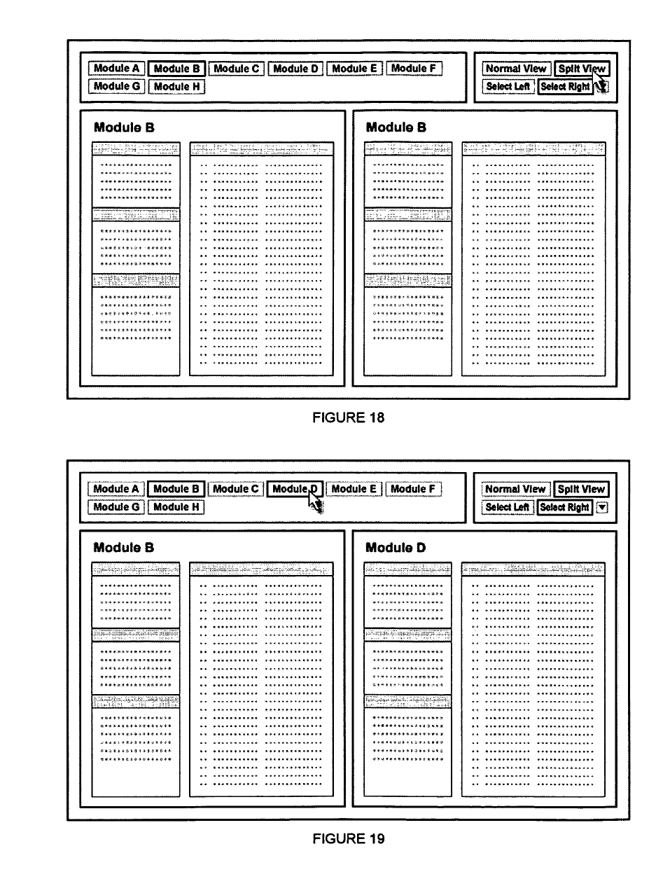

FIG. 18 shows an example of the result when the user starts with the view illustrated in FIG. 17 and then clicks the split view button.

Clicking the split view button caused the GUI to switch to the split viewing mode. In the example shown, the GUI displays Module B (the module displayed before the event in the normal viewing mode) on both sides of the split view.

The right selecting mode is in effect after the illustrated event.

Note: The application may be configured to handle this event somewhat differently; for instance, when the user switches from normal viewing mode to split viewing mode by clicking the split view button, the result may be that the already-selected module (in this case Module B) is shown on one side of the split view and the module most-recently displayed prior to Module B is displayed on the other side. Also, the system may be configured such that switching from normal viewing mode to split viewing mode by clicking the split view button results in the automatic selection of the left selecting mode, or the final selecting mode may be selected according to a user-preference setting, or it may be calculated according to user history, or it may be determined by another means.

FIG. 19 shows an example of the result when the user starts with the view illustrated in FIG. 18 and then clicks a module selection button labeled “Module D”.

Because the right selecting mode was in effect when the user clicked the “Module D” button, clicking the “Module D” button resulted in the GUI displaying Module D in the right module display panel.

Module B continues to be displayed in the left module display panel.

The right selecting mode remains in effect after the illustrated event.

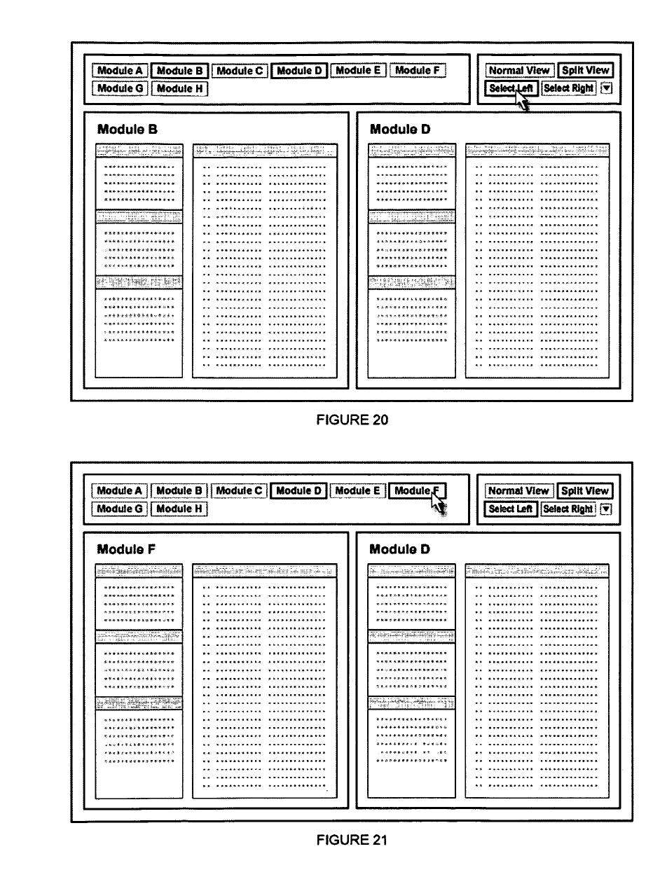

FIG. 20 shows an example of the result when the user starts with the view illustrated in FIG. 19 and then clicks the select left button (labeled “Select Left”).

The GUI is in the left selecting mode after the illustrated event.

FIG. 21 shows an example of the result when the user starts with the view illustrated in FIG. 20 and then clicks a module selection button labeled “Module F”.

Because the left selecting mode was in effect when the user clicked the “Module F” button, clicking the “Module F” button resulted in the GUI displaying Module F in the left module display panel.

The left selecting mode remains in effect after the illustrated event.

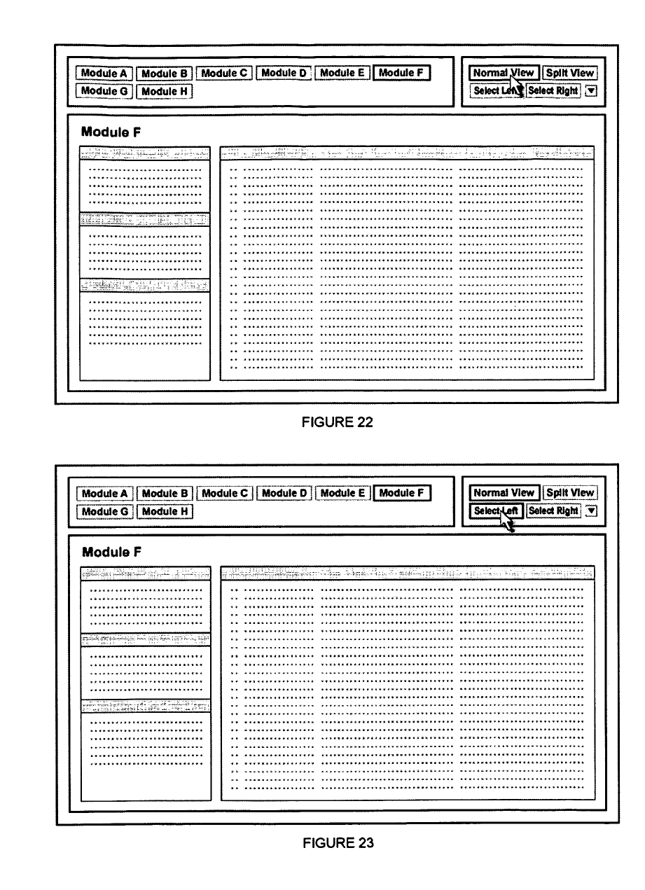

FIG. 22 shows an example of the result when the user starts with the view illustrated in FIG. 21 and then clicks the normal view button (labeled “Normal View”).

Because the left selecting mode was in effect when the user clicked the normal view button, clicking the normal view button resulted in the GUI displaying Module F in the normal viewing mode.

The normal selecting mode is in effect after the illustrated event.

In a typical configuration of the GUI, when the user switches from the split viewing mode to the normal viewing mode by clicking the normal view button, the module displayed on the side of the split view corresponding to the selecting mode in effect will be displayed in the resulting normal view. That is, if the left selecting mode was in effect when the user clicked the normal view button, the module that was displayed on the left side of the split view will be displayed in the normal view; if the right selecting mode was in effect when the user clicked the normal view button, the module that was displayed on the right side of the split view will be displayed in the normal view.

Alternatively, the GUI may be configured such that the module displayed in the resulting normal view is selected in a different manner. For instance, the GUI may be configured such that when the user switches from split viewing mode to normal viewing mode by clicking the normal view button, the last selected module will be displayed in the resulting normal view. The GUI may be configured such that the module displayed in the resulting normal view is determined in other ways, as well.

FIG. 23 shows an example of the result when the user starts with the view illustrated in FIG. 22 and then clicks the select left button (labeled “Select Left”).

The GUI remains in the normal viewing mode, and the left selecting mode is in effect after the illustrated event.

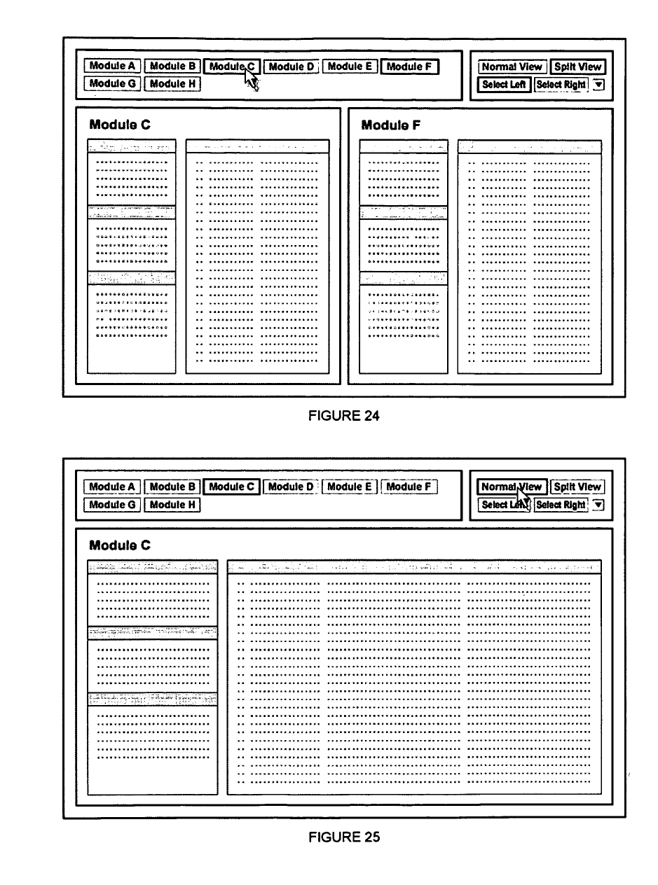

FIG. 24 shows an example of the result when the user starts with the view illustrated in FIG. 23 and then clicks a module selection button labeled “Module C”.

Because the left selecting mode was in effect when the user clicked the “Module C” button, clicking the “Module C” button resulted in the GUI switching to the split viewing mode and displaying Module C on the left side. After the event, Module F is displayed on the other (right) side of the split view.

The left selecting mode remains in effect after the illustrated event.

FIG. 25 shows an example of the result when the user starts with the view illustrated in FIG. 24 and then clicks the normal view button (labeled “Normal View”).

Because the left selecting mode was in effect when the user clicked the normal view button, and because Module C was displayed on the left side of the split view, clicking the normal view button resulted in the GUI switching to normal viewing mode and displaying Module C.

The normal selecting mode is in effect after the illustrated event.

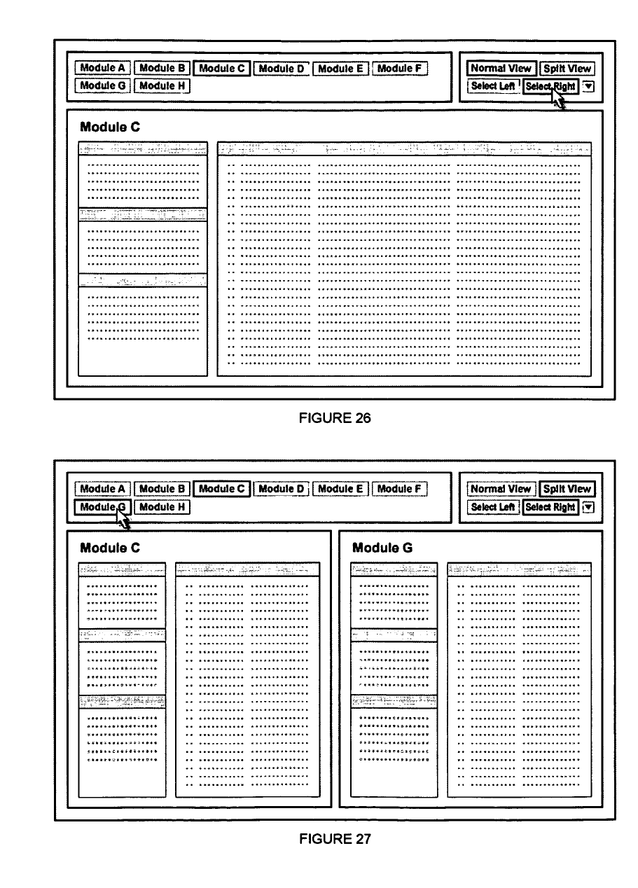

FIG. 26 shows an example of the result when the user starts with the view illustrated in FIG. 25 and then clicks the select right button (labeled “Select Right”).

The GUI remains in normal viewing mode, and the right selecting mode is in effect after the illustrated event.

FIG. 27 shows an example of the result when the user starts with the view illustrated in FIG. 26 and then clicks a module selection button labeled “Module G”.

Because the right selecting mode was in effect when the user clicked the “Module G” button, clicking the “Module G” button resulted in the GUI switching to split viewing mode and displaying Module G on the right side. After the event, Module C is displayed on the other (left) side of the split view.

The right selecting mode is in effect after the illustrated event.

The following sections describe additional view-management features that are generally provided by the GUI.

In addition to the basic view management features illustrated above, a typical configuration of the GUI will provide additional features for setting up and managing views.

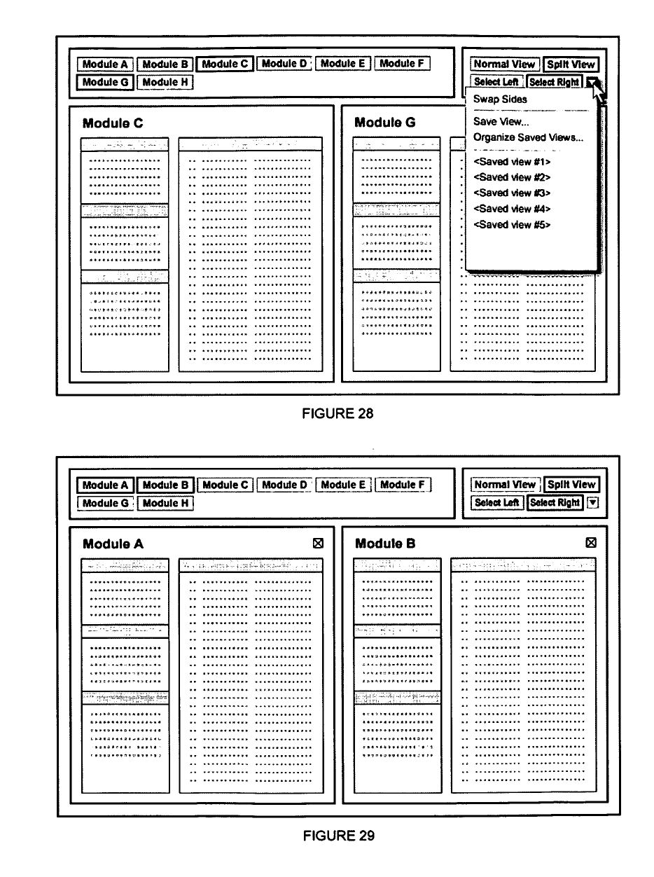

FIG. 28 shows an example of the module view setup menu in a typical configuration of the GUI.

In the illustrated example, the module view setup menu provides a feature that allows the user to swap the modules in a split view (moving the left-side module-view to the right side and the right-side module-view to the left side).

In the illustrated example, the module view setup menu also provides features that allow the user to save views, to organize saved views, and to recall saved views. When the user clicks “Save view . . . ” the application will typically provide a dialog box allowing the user to name the current view and select options for saving the view. Options for saving the view will typically include options for determining the level of specificity for saving the view; for instance, the user may save the view in such a way that recalling the view will recall specific list view options (such as a specific list and/or specific list-filtering options) and/or specific records, or the user may save the view in such a way that recalling the view will simply recall the viewing mode and the selected module or modules. In a typical configuration of the GUI, the user will be able to organize the saved views by reordering them, by renaming them, and/or by organizing them into folders and subfolders. The user may also be able to assign a given saved view to appear on a menu that is specific to a particular module or list; that is, a given saved view may appear in a menu that is accessible through the module display panel when a specific module is displayed. The user is generally able to recall a saved view by selecting it from the module view setup menu. When the user recalls a saved view, the GUI will enter the appropriate viewing mode (either normal viewing mode or split viewing mode) and show the module-view or module-views as saved, and the GUI will recall any additional viewing options that were saved with the view.

The user may also be able to assign keystrokes to saved views for the purpose of recalling saved views using the keyboard rather than the module view setup menu.

In the same way that the module view setup menu generally allows the user to recall saved views, the GUI may be configured with pre-configured “saved” views for “one-click setup” of useful views. For instance, a Projects module may be configured to include two lists of projects: one list being the user's personal list of current projects (perhaps called “My Projects”) and the other list being a “remote view” of the “master” list of projects on an enterprise system (perhaps called “All Company Projects”); the projects module may be configured to manage links (record-references) between the two lists; when the user is viewing either of the two lists, the user may often find it useful to switch to a view of that shows both lists at the same time; a button for switching to that specialized view might be placed on the button bar of the Projects module or in a similarly useful place. Another example where a pre-configured “saved” view might be useful would involve an E-mail module and a Projects module; a button on the E-mail module-view could set up a split view with “un-filed” e-mail items listed on the left and the user's current projects listed on the right; the user could use that view to drag-and-drop e-mail items onto project records to create references between the e-mails and the projects, effectively “filing” the e-mails according to project.

The GUI generally supports drag-and-drop features for managing data. (The term “drag-and-drop features” refers to features for managing data that involve the user visually “dragging” a graphical representation of an item (record, folder, file, etc.) and “dropping” that graphical representation onto a graphical representation of another item or onto another graphical element, such as an icon or control feature.) Such drag-and-drop features generally provide techniques for creating new items (records), for creating and managing links (stored references) between organizer items (including organizer records, files, and other data elements that may be stored by or represented within the system), and for performing other data-management activities. For example, a user may be able to create a local organizer record (a proxy record) by dragging-and-dropping an item from a list of “remote items” that are stored on an enterprise system (or web-based system) (i.e. that are “owned by” the enterprise or some other party) to a list of “local items” that are primarily created and modified by the user (i.e. that are “owned by” the individual user). For another example, the user may be able to create a link between an e-mail item and a project record by dragging-and-dropping the e-mail item onto the project record (or vice versa). The ability of the GUI to provide split views (generally) and inset lists (such as in record-detail views) that support drag-and-drop functionality is an important aspect of the organizer's design as a database-oriented application that is both “highly relational” and “highly intuitive”. It should be noted that creating links between items (records, files, etc.) in this manner can be used as a method for adding items to lists; for instance, creating a link between an e-mail item and a project record “adds” the e-mail item to the list of e-mail items associated with that project record; creating such a link will cause the e-mail item to appear on an inset list of related e-mail items that may be displayed on the details display panel when the details panel shows the details of the project record in question.

In a typical configuration of the system, the GUI controls, such as the module navigation controls (i.e. the module selection buttons and the buttons and menu on the module view setup panel), the list view options panel controls, and other controls can generally be activated while dragging items (while using drag-and-drop features such as those described above). Generally, the user can activate a control by pausing the cursor over the control (i.e. by moving the cursor over the control and holding it still) momentarily. For example, if a user is viewing an E-mail module in normal viewing mode, the user may be able to link an e-mail item to a project record by performing the following sequence of actions: the user locates the e-mail item on a list in the E-mail module; the user moves the cursor over the e-mail item; the user clicks the item and holds the button down to begin dragging the item; while dragging the item, the user moves the cursor over the module selection button for a Projects module and pauses; after a moment, the button is activated and the GUI switches to show a view of the Projects module; still dragging the item, the user moves the cursor over the name of the list in the list view options panel that contains the target project record, and the user pauses again; after a moment, the view changes to show the selected list of project records; the user drags the e-mail item over the desired project record and releases the button, thus dropping the e-mail item onto the project record and causing the system to create a link between the two items.

User preference settings may be provided that: allow the user to enable and disable drag-and-drop navigation features; set the length of the hover-pause that triggers the buttons (for doing so, the GUI may provide quantitative preference-setting controls such as “time in (tenths of) seconds” and/or the GUI may provide qualitative preference-setting controls such as “short/medium/long” radio buttons); allow the user to control whether hovering over a module selection button in normal view mode opens the newly-selected module in the normal view or in a split view (and if so, which side); allows the user to control whether, after completing a drag-and-drop that includes navigating/switching views, the GUI switches back to the original view or keeps the new view.

The GUI is generally designed to allow the user to navigate the entire system quickly and easily, even when using drag-and-drop navigation techniques. As such, the overall combination of the GUI layout and the GUI controls is designed to provide a simple and intuitive set of features for managing links between data items.

Other features of the GUI generally include “shortcuts” that the user can use to set up and manage views, including the following examples.

Double-clicking a module selection button when the GUI is in split viewing mode may cause the GUI to display the corresponding module in normal viewing mode. Double-clicking a module selection button when the GUI is in normal viewing mode may cause the GUI to display the corresponding module in split viewing mode, for example displaying the previously-displayed module on the left and the newly-selected (“double-clicked”) module on the right. The application may provide user preference settings that allow the user to enable/disable and/or modify the specific behavior of such features.

The user may be able to use modifier keys to effectively enter selecting modes; for example, holding down the “Ctrl” key while clicking a module selection button may cause the GUI to enter the right selecting mode for the purposes of processing the module-selection event; for example, if the GUI is displaying “Module A” in normal viewing mode and the user clicks the “Module B” button while holding down the “Ctrl” key, the GUI would respond by displaying a split view with Module A on the left and Module B on the right. Similarly, holding down both the “Ctrl” key and the “Shift” key while clicking a module selection button may cause the GUI to enter the left selecting mode for the purposes of processing the module-selection event.

If the GUI is in split viewing mode, clicking (or double-clicking) the split view button may cause the GUI to swap the left and right module views.

In addition to the buttons and other controls already described, the GUI may include history-related navigation buttons, such as “Back” and “Forward” buttons commonly found in Web browser applications.

FIG. 29 shows an example of “close” buttons added to module display panels in split viewing mode. When the GUI is in split viewing mode, the module display panels may provide such buttons to allow the user to “close” one of the module views by clicking the corresponding “close” button. In the example illustrated in FIG. 29, when the user clicks the “close” button on either the left module display panel or right module display panel, the GUI switches to normal viewing mode and displays (only) the module that was displayed on the other module display panel.

As described above, the organizer application will generally include a History module (or more than one “history module”, such as separate modules related to navigation history and record-modification history). The user will generally be able to recall previous views from the list or lists included in the History module.

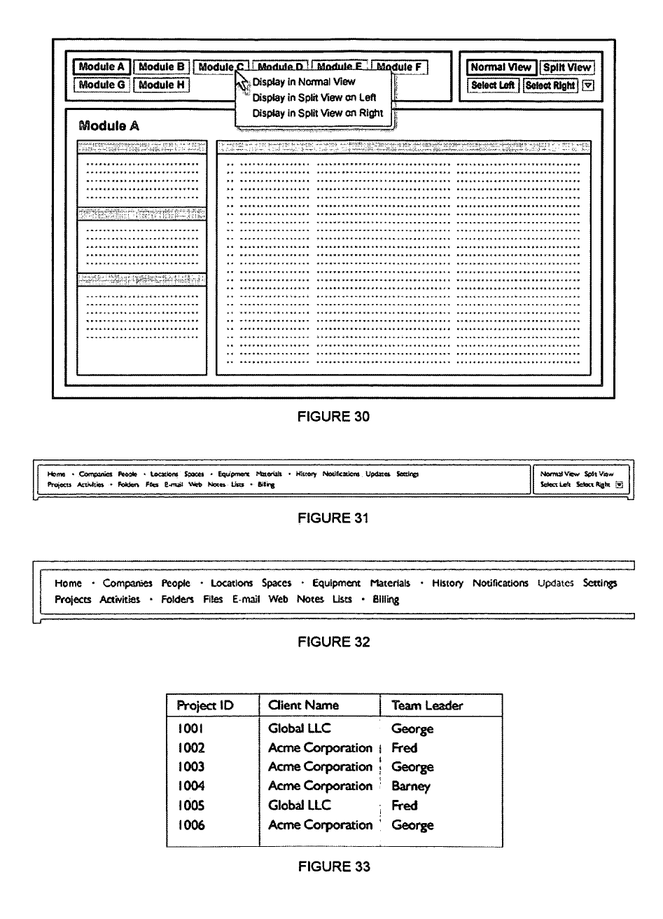

FIG. 30 shows an example of a GUI feature that provides the user with a contextual menu for a module selection button. In the illustrated example, the contextual menu allows the user to effectively select a viewing mode and a selecting mode while selecting a module. That is, the contextual menu allows the user to choose whether the newly-selected module will be displayed in the normal viewing mode; in the split viewing mode on the left; or in the split viewing mode on the right.

In comparison to the prior art, the GUI described in this document includes a number of novel features that provide significant corresponding benefits. The important novel features of the GUI include the layout of the navigation panels and the variety of features for setting up, managing, and using split views.

FIG. 31 shows a more “realistic” example of the navigation section in a typical implementation of the GUI.

As the illustrated example demonstrates, the layout of the navigation panels allows the module selection panel to display the names of a large number of modules in an understandable arrangement in a compact space. The illustrated example shows the names of 20 modules with room for about ten more names, and, if necessary, the panel can be expanded to include a third line or more. The horizontal arrangement of the module buttons especially allows the use of module names of different lengths without wasting space or cutting off characters as would be the case in a vertical/columnar arrangement.

Displaying the module names (selection buttons) in this manner provides the user with a visual overview of the entire system in a small space. Also, in a typical configuration of the GUI, the module selection names (selection buttons) are always in the same place and are always visible; that would typically not be the case in a system using another layout approach, such as a vertical arrangement of buttons or a “tab” layout design. Having all of the module names (selection buttons) always visible and always in the same locations means that, once the user becomes familiar with the layout, the user will be able to use the navigation panels and access the modules quickly and efficiently.

Furthermore, because all of the module names (selection buttons) are typically always visible, the module selection panel can be used to show status indicators to the user without needing to alter the appearance of the panel in ways that might be unpredictable, inconvenient, and possibly even confusing to the user. (That is, if the GUI were to use a layout that was not able to show all module names at once, then one or more module names would have to be hidden at any given time. For the system to provide a status indicator in conjunction with the display of module name that was not currently visible, the system would need to make that module name visible and hide one that had previously been displayed.) Status indicators may include changing the appearance of the module name, changing the background color of the module selection button, adding other visual elements such as icons near the buttons, or using other such means to present useful information to the user about the states of the system.

FIG. 32 shows an example of the module selection panel being used to present status indicators to the user. In the illustrated example, the names of the Updates, Activities, and E-mail modules are displayed in different colors (orange, red, and green, respectively); the user might understand the colors as indicating that the Updates module contains pending data-synchronization updates for the user to review; that the Activities module contains calendar items with due dates that are overdue; and that the E-mail module contains new and/or unread e-mails.

The features for setting up, managing, and using split views are important because of the “highly relational” nature of the organizer application. The organizer is designed to support relationships (record-links/stored references) among virtually all types of organizer items in order to allow the user to view and manage information in a wide variety of useful ways. The ability to quickly and easily set up views of two (or more) lists at a time and the ability to link items together using visual drag-and-drop techniques makes the organizer an efficient and intuitive tool for managing such relationships.

In addition to the features described in this document, the GUI may also include other features for managing views, working with data, and performing other functions.

The following sections describe the features that the GUI generally provides for creating and managing nested sorts in list views.

When the GUI displays a list of information with multiple columns, the GUI generally provides features that allow the user to achieve nested sorts by interacting with column headers in specific ways. In a typical configuration of the application, the user can generally create, extend, or modify a nested sort by holding down a modifier key while clicking on an appropriate column header. The following sequence of examples illustrates the typical appearance and use of the application's nested sorting features.

FIG. 33 shows an example of a list display.

In the example shown in FIG. 33, the GUI displays a list of project-related information. The columns of the list are labeled Project ID, Client Name, and Team Leader.

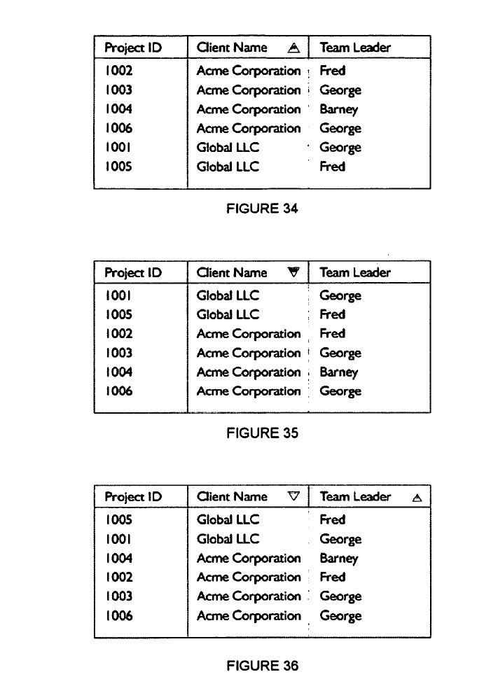

FIG. 34 shows an example of a typical result when the user starts with the view illustrated in FIG. 33 and clicks the column header for the Client Name column.

In the example shown in FIG. 34, the list is now sorted by client name. The upward-pointing triangle in the Client Name column header provides a visual indication that the list has been sorted by the Client Name column in ascending order. Clicking a column header generally causes the GUI to sort the displayed list by the values in that column.

FIG. 35 shows an example of a typical result when the user starts with the view illustrated in FIG. 34 and clicks the column header for the Client Name column.

In the example shown in FIG. 35, the list is now sorted by client name in descending order. The downward-pointing triangle in the Client Name column header provides a visual indication that the list has been sorted by Client Name in descending order. When a list has already been sorted by a given column, and the user clicks the header for that column, the GUI generally resorts the list such that the column of the clicked column header is sorted in opposite order (i.e. ascending order switches to descending order and descending order switches to ascending order).

FIG. 36 shows an example of a typical result when the user starts with the view illustrated in FIG. 35 and clicks the column header for the Team Leader column while holding down the “Shift” key on the keyboard.

In the example shown in FIG. 36, the list is now sorted using a nested sort, first by Client Name in descending order and then by Team Leader in ascending order. The GUI now displays a second, smaller triangle in the Team Leader column header to indicate the sort order for that column. Because the user held down the “Shift” key while clicking the Team Leader column header, the application retained the previously-chosen sort order (Client Name descending, as illustrated in FIG. 35) as the “top level sort order” and incorporated a sort on the Team Leader column as a “second level sort order”—i.e. within a group of items sharing the same value for the “top level sort order”, the list items are sorted according to the values of the “second level sort order”.

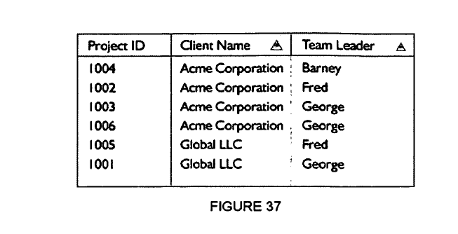

FIG. 37 shows an example of a typical result when the user starts with the view illustrated in FIG. 36 and clicks the column header for the Client Name column while holding down the “Shift” key on the keyboard.

In the example shown in FIG. 37, the list has retained the previous nesting of columns, but the sort order for the Client Name column has been reversed so that it is now in ascending order. Holding the “Shift” key while clicking an already-nested column will maintain the nested sort and maintain the order by which the columns are sorted, but it will reverse the sort order for the corresponding column.

If the user begins with the view shown in FIG. 37 and clicks the column header for the Client Name column (without holding down the “Shift” key), the GUI will return to the example view shown in FIG. 34—i.e. with the list sorted only by the Client Name column. Clicking a column header without holding down the “Shift” key generally clears any nested sort and sorts the list only by the corresponding (“clicked”) column. If the user clicks a column header (without holding down the “Shift” key) on a list while a nested sort is in effect for that list, and if the column of the clicked column header is part of the nested sort, then the click-event generally does not result in the reversal of the column's sort order; rather, the column may automatically be sorted by its default sort order; alternatively, the column may retain the previously-established sort order.

In some configurations of the system (or by changing user preference settings), the user may be able use different modifier keys or key-combinations (in addition to or instead of the “Shift” key) to create nested sorts.

The user may be able to create nested sorts by using a contextual menu accessed at the column header (or, possibly, anywhere in the column). For example, if the user starts with the example view shown in FIG. 35 (which illustrates a “simple” sort), the user may be able to achieve the example view shown in FIG. 36 (which illustrates a nested sort) by right-clicking on the Team Leader column header and selecting from a contextual popup menu an option labeled “Nested Sort”.

The GUI may indicate the sort direction and sort order of sorted columns using visual indicators other than the upward- and downward-pointing triangles shown in the example column headers.

The GUI generally supports nested sorts of two levels or more—i.e. the user can generally achieve nested sorts using two, three, or four columns, or as many columns are on the list. The user can generally keep adding columns to the sort order by holding down the “Shift” key and clicking additional column headers (or repeat whatever other technique may be available for creating nested sorts). The column-order of the sort generally corresponds to the order in which the columns have been selected.

The following sections describe the features that the GUI generally provides for using explorer-type views.

The GUI generally provides a number of features for viewing and managing information that are based on graphical “explorer” (or “tree view”) controls. The explorer controls provide a useful alternative method for navigating, viewing, selecting, and managing data in the application.

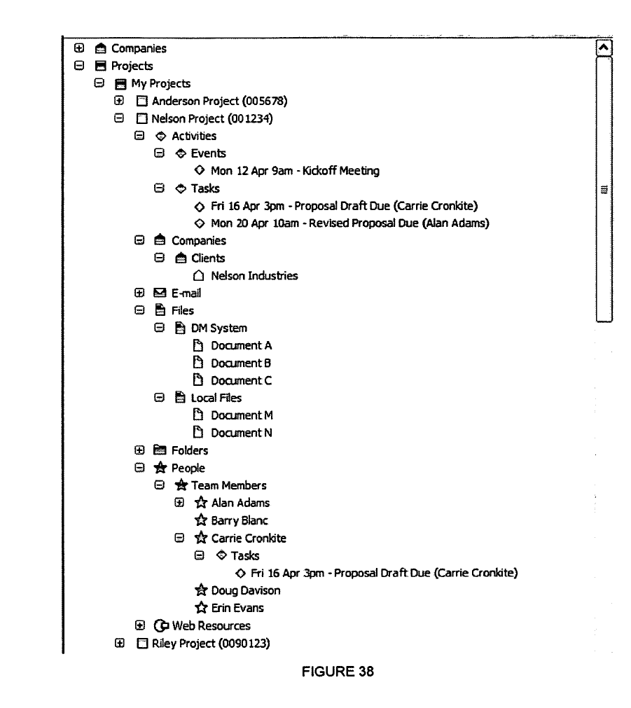

FIG. 38 shows an example of an explorer view displaying organizer data.

Such explorer views are commonly provided by operating systems for navigating folder/file structures on computer systems. Also, explorer views have been used (if less frequently) as navigation features on web pages. The organizer application described in this document uses explorer views to display not only folders and files, but virtually all types of data elements, including data managed in the personal organizer application. The organizer is designed to manage information of many types, such as: Companies, People, Locations, Spaces, Equipment, Materials, Projects, Activities, Folders, Files, E-mail, Web Resources, and others. The application is designed to allow the user not only to manage such pieces of information, but also to manage information about the relationships between such types of information—that is, the application provides a variety of features for managing relationships between pieces of information, whether of the same type or of different types. For example, a given Company record may be related to: a number of People records that contain information about the company's employees; to a number of Project records that contain information about projects related to that company; and to one or more Location records that contain information about the company's locations. For another example, a given Project record may be related to: a Company record that contains information about the corporate client for the project; a number of People records that contain information about members of the team working on the given project; a number of Activity records that contain information about specific tasks related to the given project; a number of Folder, File, E-mail and Web Resources items that contain content related to the project; etc. The organizer application's GUI generally provides explorer views as an additional means for navigating, viewing, and managing “relational” information (i.e. in addition to using “normal” list views and record-details views). Depending upon what the user wishes to accomplish at a given moment, the user may find an explorer view to be a preferable method of interacting with the application.

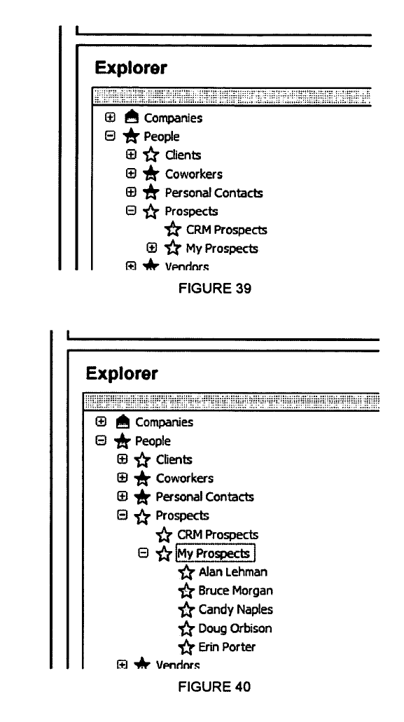

FIG. 39 shows an illustration of an explorer view displaying organizer information.

In the example illustrated in FIG. 39, the user has clicked the People and Prospects elements to reveal more detailed information.

FIG. 40 shows an example of a possible result when the user starts with the view illustrated in FIG. 39 and clicks the My Prospects element. In the example illustrated in FIG. 40, the names of the People records belonging to the My Prospects list are displayed in the explorer view.

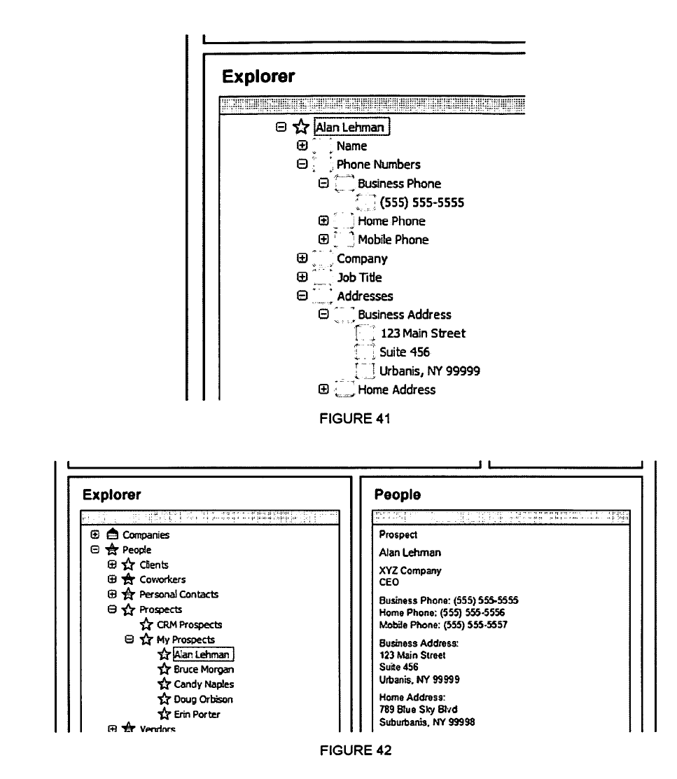

FIG. 41 shows an example of a possible result when the user starts with the view illustrated in FIG. 40 and clicks the Alan Lehman element. In the example shown in FIG. 41, the details of the Alan Lehman record are displayed as part of the explorer view.

FIG. 42 shows an example of a second possible result when the user starts with the view illustrated in FIG. 40 and clicks the Alan Lehman element. In the example shown in FIG. 42, the details of the Alan Lehman record are displayed in a details display panel in a view of the People module that has opened in a split view.

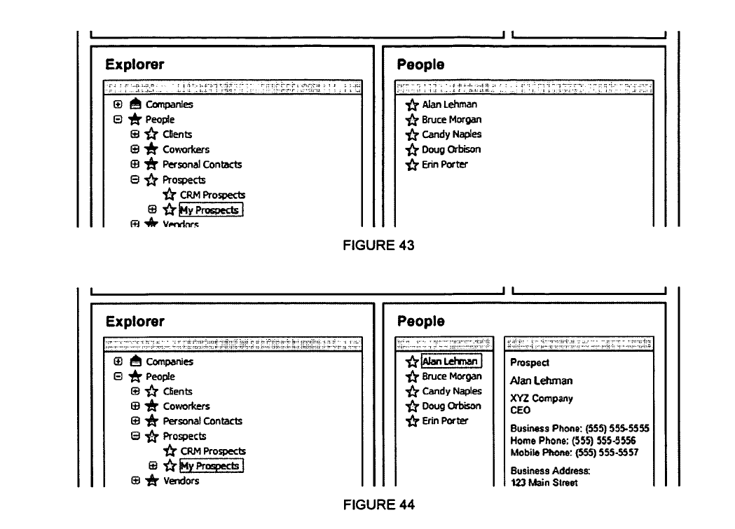

FIG. 43 shows an example of a second possible result when the user starts with the view illustrated in FIG. 39 and clicks the My Prospects element. In the example illustrated in FIG. 43, the corresponding People records are listed in a view of the People module that has opened in a split view.

FIG. 44 shows an example of a possible result when the user starts with the view illustrated in FIG. 43 and clicks on the Alan Lehman element. In the example illustrated in FIG. 44, a details display panel has opened to display the details of the Alan Lehman record in the module display panel that shows a view of the People module.

The GUI generally provides drag-and-drop features, contextual menu options, and other features in conjunction with explorer views that allow the user to manage data (including managing relationships between records/items) by interacting with the data displayed in those views.

The following sections describe the features that the GUI generally provides for supporting relationship types (or ‘association classes’ in UML parlance) in the system.

The Tekton System, including the Tekton Organizer application, generally includes a design element called a relationship type. A relationship type generally provides specific information about the way that two objects relate to one another. A given relationship type may generally be attributed to a relationship—i.e. to a link—between two items. For example, a relationship type may be attributed to a link between two Company records or to a link between a Project record and a Person record. Relationship types generally allow the system to manage and display useful types of information about the ways that different events and/or objects relate to one another in the user's “real-world” environment.

Relationship types are generally used to indicate information about the way that two linked items are related to one other. Relationship types supply information about the relationship itself. That is, relationship types generally provide specific information about how the linked items are related to one other. For example, two Company records may be linked to one another in the system; a relationship type may be applied to the link to indicate that the corresponding companies share a client-vendor relationship; also, the link may carry information about which company is the vendor and which company is the client in the given relationship. For another example, a given Project record may be linked to seven Person records (using seven corresponding links); one of the Project-Person links may indicate that the corresponding person is the team leader for the project; another of the Project-Person links may indicate that the corresponding person is the billing partner for the project; another of the Person-Project links may indicate that the corresponding person is the client contact for the project; the remaining four links may indicate that the corresponding people are team members for the project.

Relationship types are generally applied by linking a relationship type record to an item link record, where the item link record represents the link between two items. When two items are linked and a relationship type is linked to the link between the two items, the relationship type generally describes what each item “means” to the other. Put another way, the relationship type generally describes the role that each item plays in the given relationship. Thus, a relationship type generally implies a complimentary pair of perspectives. For example, in the Company-to-Company link example provided above, one company regards the second company as “my vendor”, and the second company regards the first as “my client”.

Relationship types enable the system to provide many useful features for viewing, managing, and using information. Relationship types also generally provide valuable features for configuring the system for particular user environments and for extending the system in various ways. Relationship types provide a mechanism whereby associations between organizer item classes may be configured at runtime. Relationship types may be said to provide the system with a feature that allows association classes (as described in the Up) to be configured “dynamically”.

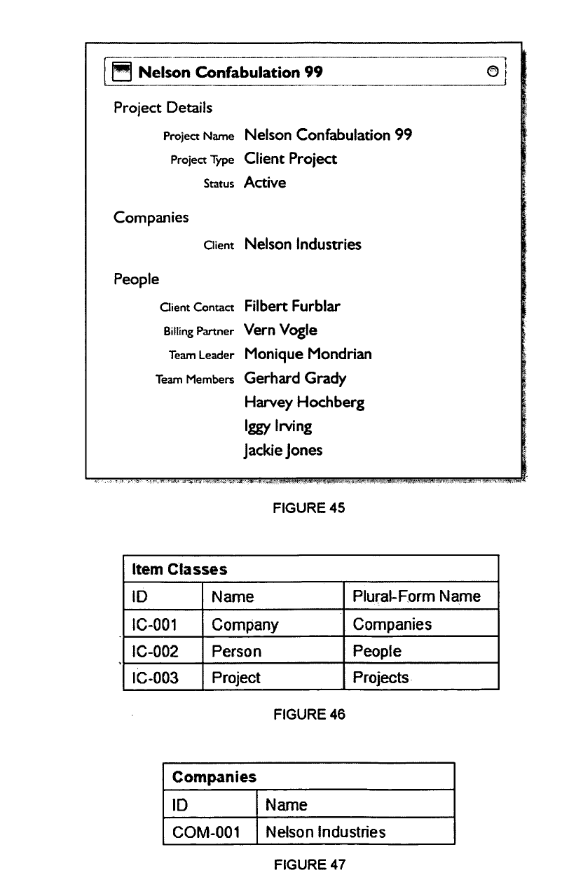

FIG. 45 shows an example of a typical Project Details view of an example Project record. The example view illustrates a typical use of relationship types in the organizer application and in the system as a whole.

In the example shown in FIG. 45, the illustrated Project Details view shows the name, type, and status of the given project. The name, type, and status of the project are pieces of information that are typically stored as part of the Project record itself. The view also shows information from other records that are linked to the Project record, including one Company record and seven Person records. In a typical configuration of the system, items (records) are generally linked through separate link records (sometimes called “join-table records”), each of which carries two references—one reference to each of the two linked records. The link records are also called item link records, or simply item links.

(Note: Records could also be linked through references stored only in the records themselves or possibly through other means.)

In the illustrated example, the information displayed from the related (linked-to) Company record includes the name of the company that is the client company for the given project. The link between the Company record and the Project record has been assigned a relationship type that might be named “Client Company to Project”; that is, the link between the Company record and the Project record has been assigned a relationship type that specifies that the “Nelson Industries” company relates to the “Nelson Confabulation 99” project as the project's client company. (The word “as” generally plays a key role in describing relationship types—i.e. “item A relates to item B as an X, and item B relates to item A as a Y”; a relationship type specifies the “X” and “Y” terms.)

In the illustrated example, the Project Details view shows information from seven related Person records. The information displayed from the related Person records includes the name of each person associated with the project. Each relationship (link) between the project and one of the people has been assigned a relationship type. The relationship type assigned to each relationship (link) provides the role name or title that is used to indicate the specific role of each participant in the relationship—e.g. with regard to the “Nelson Confabulation 99” project, Filbert Furblar is a client contact, whereas Vem Vogle is a billing partner. The relationship (link) between the “Filbert Furblar” Person record and the “Nelson Confabulation 99” Project record has been assigned a relationship type that might be named the “Client Contact to Project” relationship type; in that relationship, Filbert Furblar has been assigned the title “Client Contact”. The link between the “Vern Vogle” Person record and the “Nelson Confabulation 99” Project record has been assigned a relationship type that might be named the “Billing Partner to Project” relationship type; in that relationship, Vem Vogle has been assigned the title “Billing Partner”. The link between the “Monique Mondrian” Person record and the “Nelson Confabulation 99” Project record has been assigned a relationship type that might be named the “Team Leader to Project” relationship type; in that relationship, Monique Mondrian has been assigned the title “Team Leader”. The four links from the remaining Person records to the Project record have each been assigned a relationship type that might be named the “Team Member to Project” relationship type; in each of those relationships, the person involved has been assigned the title “Team Member”. In each relationship described, the project can be assumed to have been assigned a generic title such as “Project”.

The following figures show example tables that illustrate a possible implementation of relationship types in the system. The example tables only show data that is specifically relevant to the present discussion; in a typical implementation, such tables generally contain more columns of information, and in some cases, the information shown may be stored using somewhat different table structures. The following example tables contain data corresponding to the example Project Details view illustrated in FIG. 45.

FIG. 46 shows an example of an Item Classes table used as part of a possible implementation of relationship types in the system.

In the example implementation illustrated in FIG. 46, the Item Classes table provides the names of three item classes named Company, Person, and Project. The Item Classes table is generally used for defining/configuring the basic item classes. For each item class, the Item Classes table generally may contain: the ID of the item class; the name of the item class; alternate versions of the name of the item class (such as its plural form); references to icons associated with the class; references and values that determine the attributes and methods of the item class; references to tables of user data associated with the item class; settings related to external connections for linking class-member items with items in remote data sources; and other kinds of data. Each record in the Item Classes table generally corresponds to a user module in the organizer and describes one of the basic categories of information that the user can manage in the system.

FIG. 47 shows an example of a Companies table used as part of a possible implementation of relationship types in the system.

The example Companies table shown in FIG. 47 corresponds to a list of companies that the user might manage in the organizer application (or elsewhere in the system).

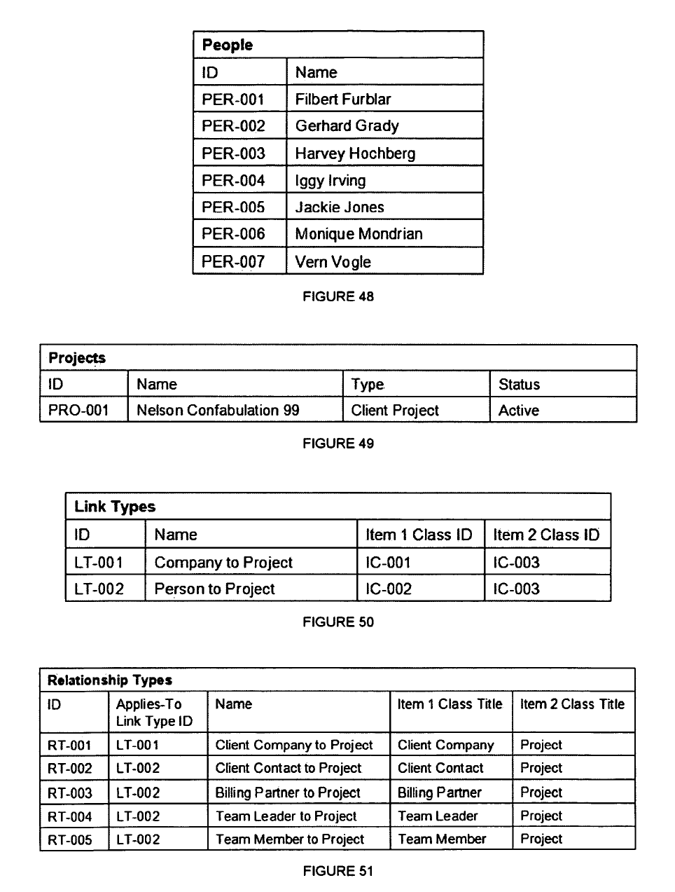

FIG. 48 shows an example of a People table used as part of a possible implementation of relationship types in the system.

The example People table shown in FIG. 48 corresponds to a list of people that the user might manage in the organizer application (or elsewhere in the system).

FIG. 49 shows an example of a Projects table used as part of a possible implementation of relationship types in the system.

The example Projects table shown in FIG. 49 corresponds to a list of people that the user might manage in the organizer application (or elsewhere in the system).

The example project record listed in FIG. 49—named “Nelson Confabulation 99”—corresponds to the item shown in the example Project Details view shown in FIG. 45.

FIG. 50 shows an example of a Link Types table used as part of a possible implementation of relationship types in the system.

An implementation of relationship types may include a Link Types table. In a typical Link Types table, each link type corresponds to a specific combination of item classes that may be represented in any given item link. That is, there may be a link type defined for any or every pair of item classes that support item links and for every item class that supports same-class links (i.e. via a “reflexive association” in UML parlance). Thus, given the item classes shown in FIG. 46, in addition to the link types shown in FIG. 50, other possible link types include a “Company to Person” link type, and “Company to Company” link type, and a “Person to Person” link type. In a typical implementation of relationship types, link types correspond to combinations of item classes rather than permutations of item classes; the order of the item classes is generally not relevant to determining the corresponding link type. That is, a “‘Company to Project’ link” is—for the purpose of identifying a link type—the same as a “‘Project to Company’ link”. However, given a link between a Company item and a Project item, the system may always consider the Company item to be “Item 1” and the Project item to be “Item 2” for the purposes of handling corresponding references and values in a consistent way. Nonetheless, that does not mean that the item link itself is necessarily “directional” (although it may be “directional” in some cases).

The example Link Types table shown in FIG. 50 contains two link type definitions, which include references to the Item Classes table illustrated in FIG. 46. According to the illustration, a link between a Company item (Item Class ID=“IC-001”) and a Project item (Item Class ID=“IC-003”) corresponds to the “Company to Project” link type. Also according to the illustration, a link between a Person item (Item Class ID=“IC-002”) and a Project item (Item Class ID=“IC-003”) corresponds to the “Person to Project” link type.

In the example implementation illustrated by the Link Types table shown in FIG. 50, each of the link types are defined such that the Class ID values associated with each link type are assigned designations “Item 1 Class ID” and “Item 2 Class ID” in ascending order with regard to Class ID; that is, in cases involving two different item classes, the item class with the “lower” Item Class ID value is always considered “Item I”, and the item class with the “higher” Item Class ID value is always considered “Item 2”; likewise, when a link type is calculated for a given link between two items, the Class ID values are ordered in a corresponding ascending manner before being looked up in the Link Types table. Some such other method may be employed for effectively managing “un-ordered”/“non-directional” item links, when necessary.

Link types are generally used in conjunction with relationship types to control which relationship type or types may be applied to which item links. For example, a relationship type may be named “Team Leader to Project”; such a relationship type would generally be applicable to a link between a Person item and a Project item; however, it would generally not be applicable to a link involving any other combination of classes, such as a link between a Company item and a Person item or a link between two Person items.

In a typical implementation of relationship types, the Link Types table may indicate which relationship type is the default relationship type for a given link type. For example, the default relationship type for a Person to Project link may be a “Team Member to Project” relationship type; in that case, if the user were to create a link between a Person record and a Project record without specifying another relationship type, then the system would apply the “Team Member to Project” relationship type to the link automatically, thus assigning a “Team Member” role to the corresponding person. Alternatively, one or more separate related tables may be used to indicate default relationship types for link types.

In a typical implementation of relationship types, the Link Types table may contain additional kinds of information pertaining to link types.

FIG. 51 shows an example of a Relationship Types table used as part of a possible implementation of relationship types in the system.

A typical implementation of relationship types in the system includes a Relationship Types table, which defines the relationship types used in the system. Each record in the Relationship Types table generally provides a definition for one relationship type. Each relationship type definition generally indicates: to which link type (or link types) the relationship applies; the name of the relationship type; and the titles (i.e. role names) to be used for each participant in a corresponding item link. The Relationship Types may include other kinds of information about the relationship types, as well.

An implementation may use a separate table for applies-to joins to allow individual relationship types to apply to more than one link type.

In a typical implementation of relationship types, the Link Types table and/or the Relationship Types table and/or one or more additional tables may include information that influences how and where corresponding links, linked items, and related data are displayed on the various display panels of the GUI.

In a typical implementation of relationship types, one or more tables may include information that determines how certain links may be created and/or managed with regard to “link multiplicities”. The term “link multiplicities” refers to the number of links, link types, and/or relationship types that may be established at any given time for a given item or item link. Link multiplicities may be described and controlled at the item level, at the link level, at the link type level, and/or at the relationship type level. Rules for controlling link multiplicities may be indicated with static values and/or may be calculated dynamically. Examples of describing and controlling link multiplicities include possible configurations in which: a given Project record may support up to one “Person to Project”-type link at a time with the relationship type “Team Leader to Project”; a given Project record may support an unlimited number of “Person to Project”-type links at a time with the relationship type “Team Member to Project”; a given Person-Project pair may support two links simultaneously with the relationship types of “Billing Partner to Project” and “Team Leader to Project” or with relationship types of “Billing Partner to Project” and “Team Member to Project” but not with the relationship types of “Team Leader to Project” and “Team Member to Project” (that is, a given Project record may support designating one person as both billing partner and team leader, and may support designating one person as both billing partner and team member, but may not support designating one person as both team leader and team member); etc. Also, some configurations of the system may support the assignment of multiple relationship types to individual item links.

Also, the relationship type of one link may influence the applicability of relationship types to another link. For instance, a relationship type may be applied to a link between a Person record and a Company record designated as the “Home” Company (i.e. the user's own company) to indicate the user's role (job title) in the company that licenses the system; that relationship type may indicate that the user is an “Associate” in the given company; the “Associate” designation may make a “Billing Partner” role inapplicable in a link between the user's Person record and a Project record; on the other hand, for a link between a Person record and a Project record in which the person is designated as a “Partner”, the default relationship type for the link may be “Team Leader to Project”.

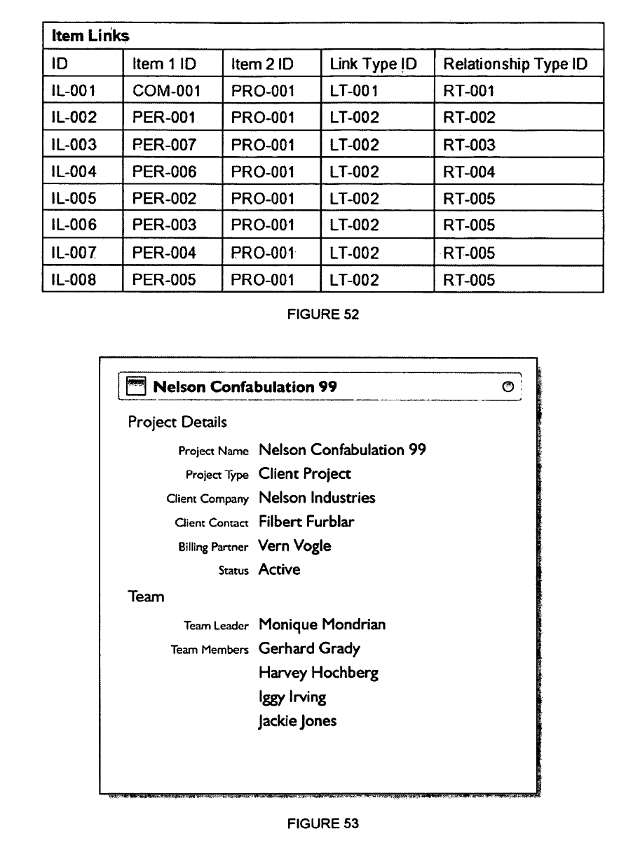

FIG. 52 shows an example of an Item Links table used as part of a possible implementation of relationship types in the system.

In a typical implementation of relationship types (or of the system more generally), the Item Links table generally contains one record for every item link (or for every item link with an associated relationship type). Each item link record generally indicates: which items are linked; which relationship type has been associated with the link; and (by virtue of the item designations as “Item 1” and “Item 2”) which item corresponds to which role in the relationship.

In addition to the features describe above, relationship types may be implemented in conjunction with item types (as described in an earlier document) to provide enhanced features with regard to item link configuration and use. For example, if a system is configured with Person types including “Coworker” and “Client Contact”, link types and relationship types may be configured such that the default relationship type for a link between a Coworker and a Project is “Team Member to Project” and the default relationship type for a link between a Client Contact and a Project is “Client Contact to Project”.

The example Item Links table illustrated in FIG. 52 contains a record for every item link illustrated in FIG. 45. As illustrated, the information in the Item Links table generally consists of references to the tables described above.

FIG. 53 shows an example of a possible alternate layout for the Project Details view illustrated in FIG. 45.

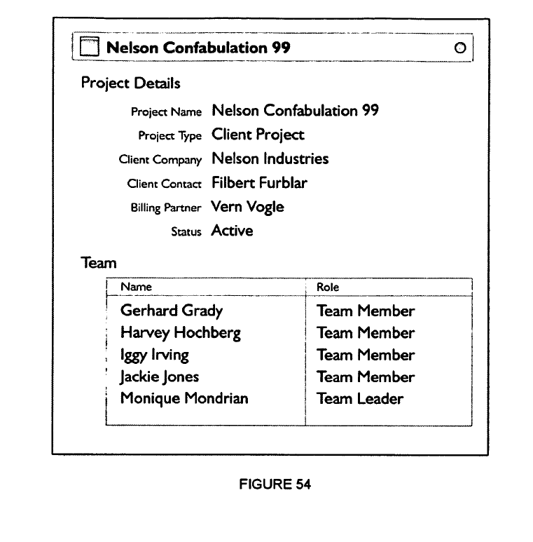

FIG. 54 shows an example of a second possible alternate layout for the Project Details view illustrated in FIG. 45.

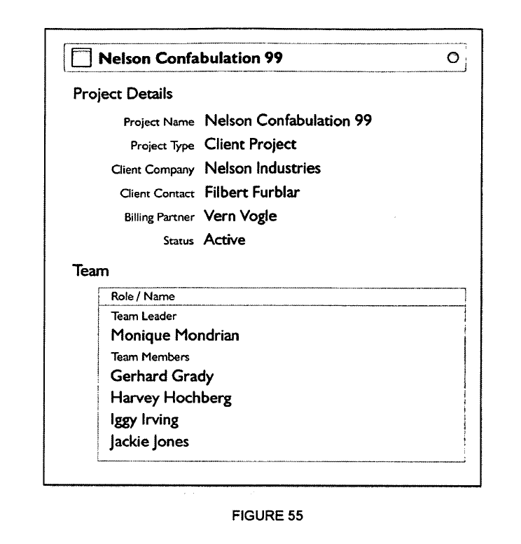

FIG. 55 shows an example of a third possible alternate layout for the Project Details view illustrated in FIG. 45.

FIG. 56 shows an example of a fourth possible alternate layout for the Project Details view illustrated in FIG. 45.

FIG. 57 shows an example of a possible explorer view displaying the information illustrated in FIG. 45.

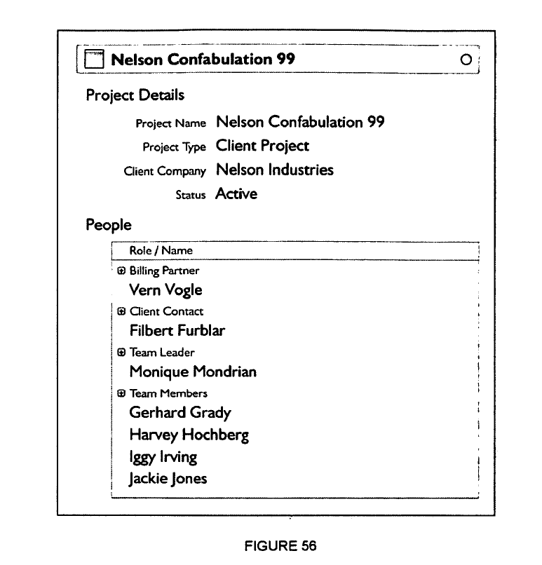

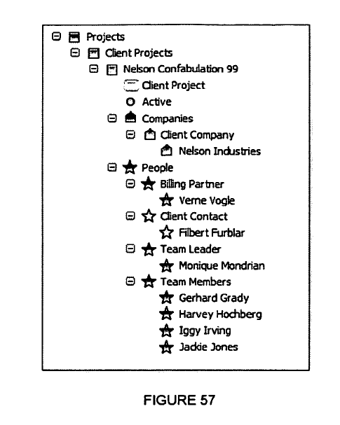

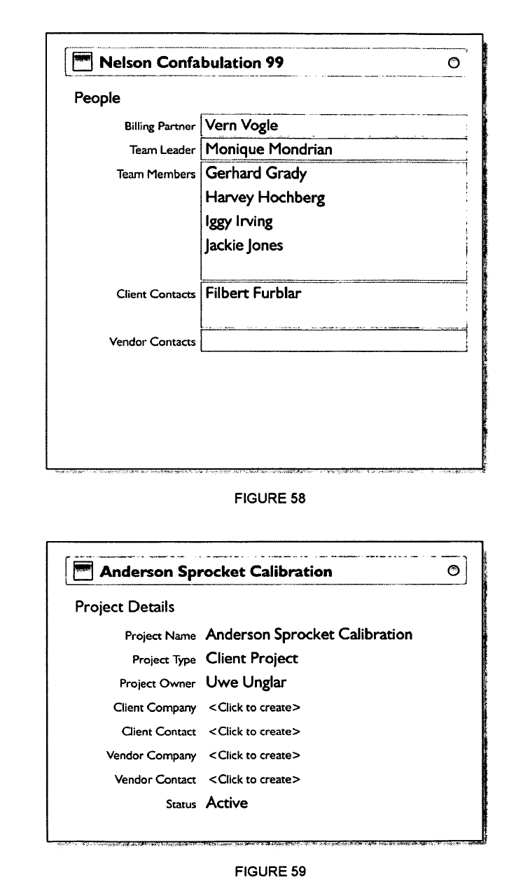

FIG. 58 shows an example of a possible “drop-zone layout” for the Project Details view illustrated in FIG. 45.

The GUI may provide a drop-zone layout that provides special features for managing relationship types as well as other kinds of information. A drop-zone layout generally appears when the user performs a drag-and-drop technique for creating or modifying an item link. A drop zone is an area of the display in which the user can drop a dragged item to achieve a specific result.

FIG. 58 illustrates a situation in which the user has begun dragging a Person record from a list (or other starting point) (not shown). Because the user is dragging a Person record, the GUI has switched the layout of the Project Details from the “standard” layout illustrated in FIG. 45 to the layout illustrated in FIG. 58. The drop-zone layout provides a drop zone for each available relationship type given the items involved. The drop-zone layout allows the user to create a link between the dragged item and the “target” item and select a relationship type at the same time. In the example shown in FIG. 58, if the user drops the dragged Person record in the box labeled “Vendor Contacts”, a link will be created between the Person record and the “Nelson Confabulation 99” Project record, and the link will be attributed a relationship type that might be called a “Project to Vendor Contact” relationship type. After the user dropped the item, the Project Details view would switch back to the “standard” view, and the name of the dropped Person record would then appear as a Vendor Contact for the Project record.

The example shown in FIG. 58 also illustrates additional features that may be implemented for drop-zone layouts. In the illustrated example, the layout provides a drop zone for each available relationship type, and there are specific target rows within each drop zone. The number of rows in each drop zone depends upon the definition configured for the corresponding relationship type. In the illustration, the Team Members drop zone has an empty row in which the user may drop a Person record; the empty row indicates that the corresponding relationship type supports multiple Person-to-Project links for each Project record. If the user drops a Person record in the empty row, the person is added to the list of team members. However, if the user drops the Person record on top of a name already on the list, the system may ask the user if the user wishes to replace the previously-listed person with the new person. Also, the illustrated view does not provide an empty row in either the “Billing Partner” drop zone or the “Team Leader” drop zone; the lack of an empty row indicates that the corresponding relationship types are configured such that only one person may be designated for each of those roles for a given project.

When the GUI shows a drop-zone layout, it may show drop zones for available relationship types only (based on the items involved). Alternatively, the drop-zone layout may show unavailable drop zones as “grayed out”. Also, a default relationship type may be highlighted, and a default relationship type may be assigned if the user drops a dragged item outside of any other available drop zone.

FIG. 59 shows an example of a Project Details view that allows the user to create linked records and assign relationship types at the same time.

In the example illustrated in FIG. 59, the user can click any of the “<Click to create>” buttons to create a linked record and assign a corresponding relationship type to the corresponding link. In the illustrated example, if the user clicks “<Click to create>” next to “Client Company”, the system will: create a new Company record; create a link between the new Company record and the illustrated Project record; and assign to the link a relationship type that might be named a “Project to Client Company” relationship type.

The following figures and text describe the features of the system that relate to relationship types in terms of object-oriented software development. The object-oriented terms are used to illustrate the general nature of relationship types and should not be taken to imply that relationship types are necessarily implemented using object-oriented programming methods. That is, the classes and other object-oriented features described below are provided as conceptual and descriptive devices only; the system may or may not be programmed in such a way that those classes and other structures are explicitly defined in the computer code as such. Nonetheless, the features described are generally implemented in a relatively uniform way throughout the system to support standardized tools and techniques for configuring and extending the system and to provide a consistent user experience when the system is configured and/or extended in different ways.

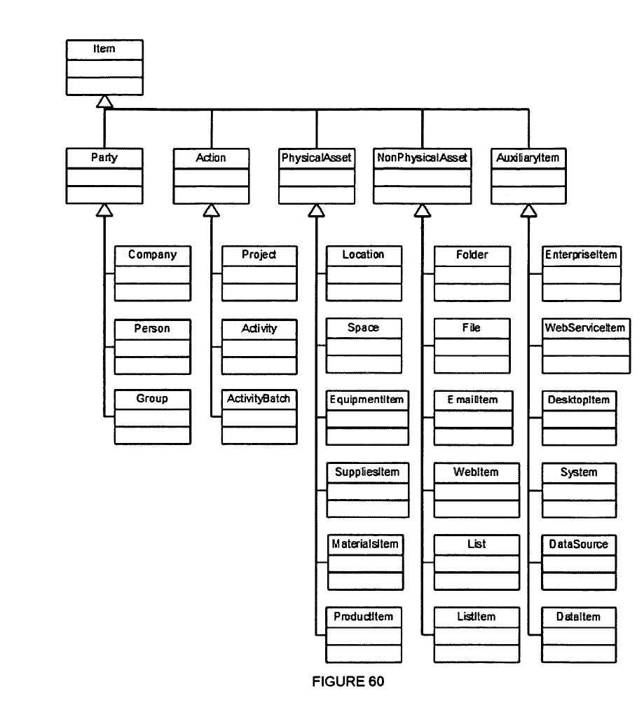

FIG. 60 shows an example of a UML-style class diagram illustrating the conceptual data model (or conceptual “domain model”) for a typical configuration of the system.

FIG. 60 shows the names and conceptual groups of the organizer classes in a typical configuration of the organizer application. The un-shaded classes correspond to the items that the user typically creates and manages.

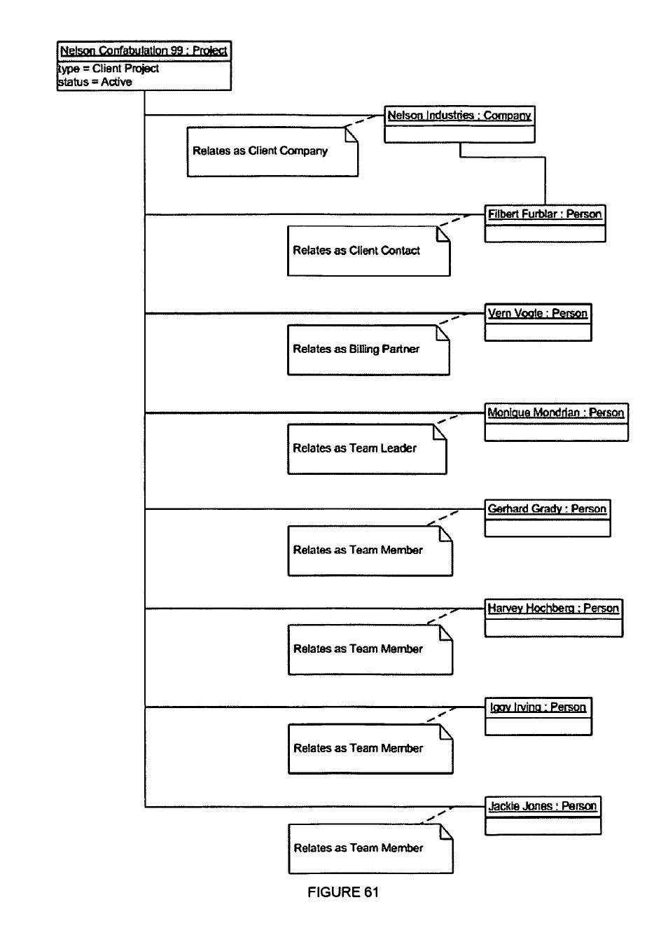

FIG. 61 shows an example of part of the data model of a typical configuration of the system.

FIG. 61 shows a UML-style object diagram illustrating the relationships between the example records illustrated in FIG. 45. The relationship types are indicated by comment boxes (rather than separate, related item link objects and relationship type objects) for space considerations.

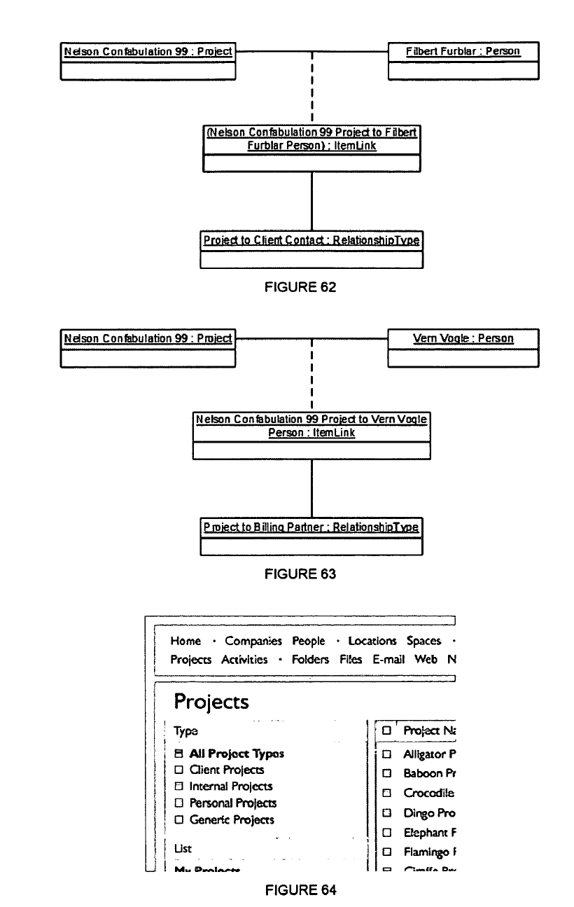

FIG. 62 shows a UML-style object diagram illustrating the relationships between some of the example records represented in FIG. 45.

FIG. 63 shows another UML-style object diagram illustrating the relationships between some of the example records represented in FIG. 45.

In addition to relationship types, the system generally supports and uses configurable item types, as described in an earlier document. (The term “item subtype” may be more appropriate in some cases from a structural point of view; however, the features described here may generally be known as “item types” to developers and users.)

Item types and relationship types can work together to provide a number of valuable features, including features for configuring, using, and extending the system.

Item types generally provide a means for configuring specialized subclasses of the basic organizer item classes, including at runtime.

FIG. 64 shows an example screenshot of a typical system that has been configured with four typical project types.

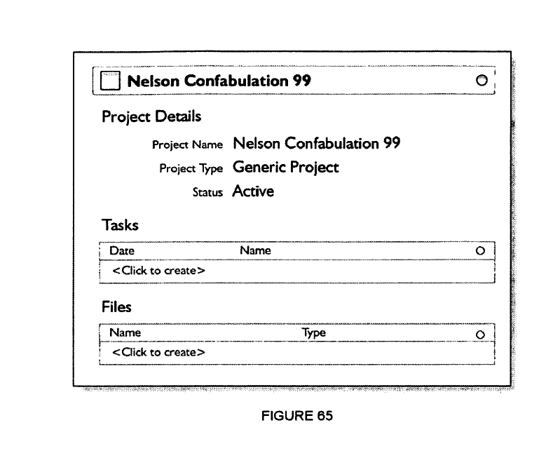

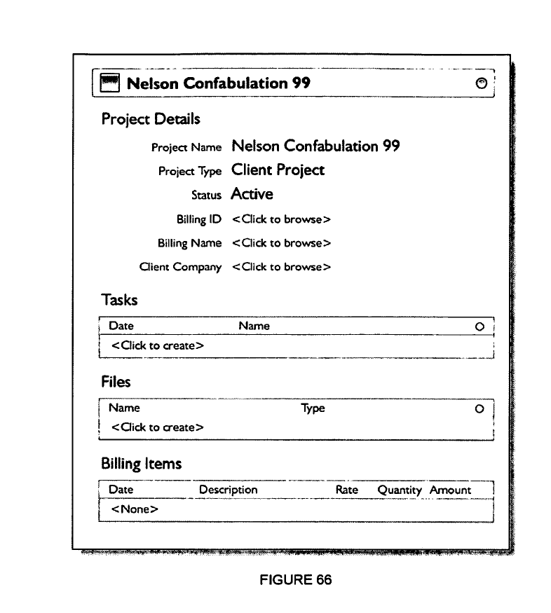

FIG. 65 shows an example of a typical Project Details view of a project item of the project type “Generic Project”.

FIG. 66 shows an example of a typical Project Details view of a project item of the project type “Client Project”.

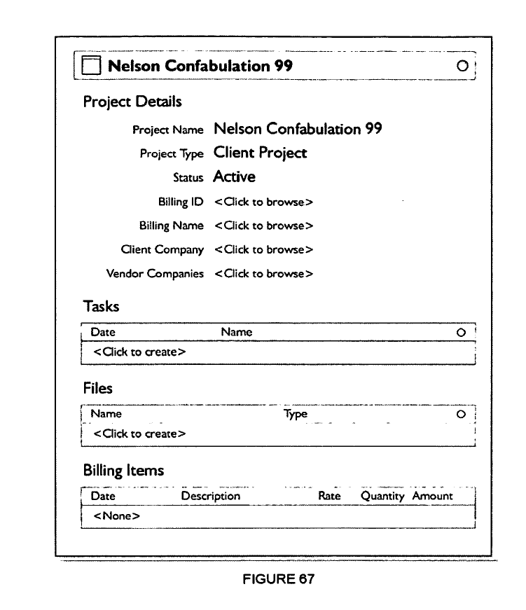

FIG. 67 shows an example of a typical Project Details view of the Client Project record illustrated in FIG. 66 with an additional relationship type configured for and applicable to the item.

Note that the Project-to-Client Company relationship type is configured to allow one link at a time per Project record, whereas the Project-to-Vendor Companies relationship type is configured to allow multiple links at a time per Project record.

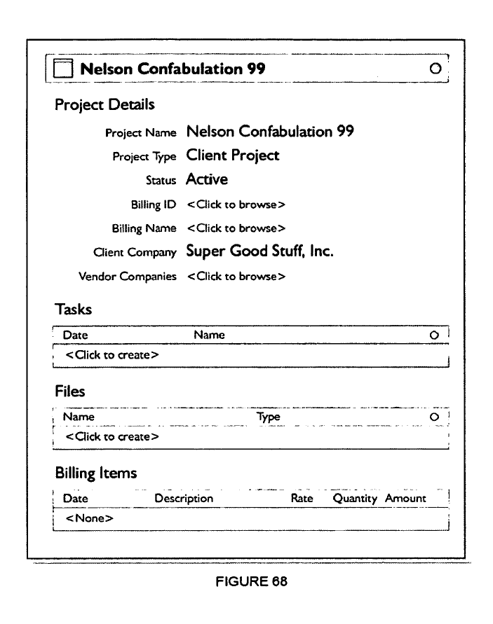

FIG. 68 shows an example of a typical Project Details view of the example project record illustrated in FIG. 67. The project record now has a link to a Company record for a company named “Super Good Stuff, Inc.”; the link has been assigned a relationship type that designates the company as the Client Company for the project.

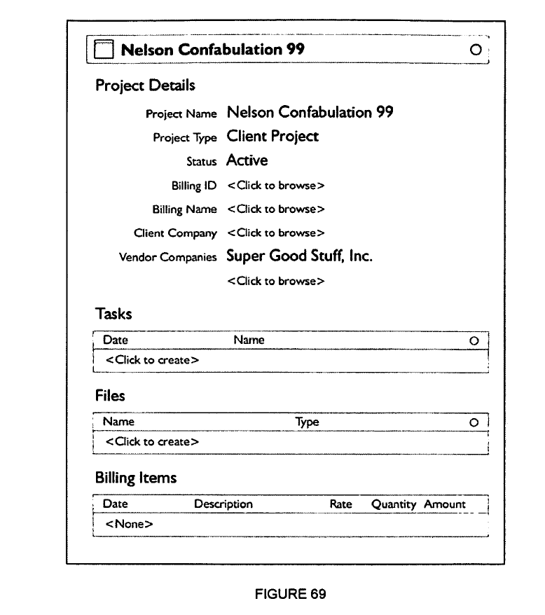

FIG. 69 shows an example of a typical Project Details view of the example Project record illustrated in FIG. 68. The relationship type for the item link to the company record has been changed such that the company is now designated as a Vendor Company for the project.

Note that the Vendor Companies section includes a “<Click to browse>” button because, in the illustrated example, that relationship type supports more than one link per Project record.

Item types and relationship types are generally implemented throughout the system in a uniform way to support standardized tools and techniques for configuring and extending the system. Together, they can be used to define item types (individual items) (by extending the base data model) and define the way that those items relate to other items. That is, together, they allow people to define the structure and behavior of items and describe the way they relate to one another.

Item types, relationship types, and external connections can generally be implemented such that they may be accessed and configured at runtime.

When creating related records (e.g. a Person record from a Company Details view), the GUI will provide options for selecting available relationship types. Also, the GUI may provide controls for creating related items based on specific relationship types.

Some class associations may support more than one link to support multiple relationship types (e.g. one person is another person's advisor and manager); alternatively or additionally, some links may support more than one relationship type (for the same purpose). Another example would be having one person indicated as both the sender and the recipient of a given e-mail. The system may generally enforce constraints such that no two links will link the same two items and also have the same relationship type. Similarly, the system may generally enforce constraints such that some pairs of items can have at most one link at a time.

Relationship types are important for the API/SDK as well. For example, they can provide efficient and powerful tools for extending the system and building related systems that communicate with the organizer and with the other applications. The system will allow developers to configure relationship types. They will be a useful resource for extending the system and rapidly developing related applications and systems, including enterprise applications and web services.

Relationship types may be employed in the security structure; e.g. each user may have a relationship type to the System (i.e. as User Roles) or to the Home Company (i.e. as job titles).

The implementation of item types can provide a mechanism that allows for the configuration of subclasses of item classes, including at runtime. That is, item types make it possible for the system to support the configuration of different types (classes and subclasses) of items at runtime.

Relationship types provide a mechanism for specifying—including at runtime—how organizer classes (and subclasses) relate to one another.

External connection definitions provide a mechanism for configuring—including at runtime—communication channels to external data sources.

The three described mechanisms, taken together, provide a set of powerful tools for configuring and/or extending the system for different user environments dynamically (including at runtime)—i.e. without changing the system's underlying code base.

The described mechanisms allow the organizer application and related applications to be customized extensively in an efficient manner to compliment different user environments and different user preferences.

In summary, persons of ordinary skill in the art will readily appreciate that a new and non-obvious user interface for a personal information manager has been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention not be limited by this detailed description of examples.

The invention is claimed as follows:

1. A method of maintaining a computerized organizer, the method comprising:
entering first organizer information into the computerized organizer;
entering first metadata into the computerized organizer, the first metadata indicating that the first organizer information is business type information;
storing the first organizer information in a first enterprise system because the first metadata indicates that the first organizer information is business type information;
entering second organizer information into the computerized organizer;
entering second metadata into the computerized organizer, the second metadata indicating that the second organizer information is personal type information;
storing the second organizer information in a non-enterprise system because the second metadata indicates that the second organizer information is personal type information;
entering third organizer information into the first enterprise system;
transmitting the third organizer information from the first enterprise system to the computerized organizer;
entering fourth organizer information into a second different enterprise system;
transmitting the fourth organizer information from the second enterprise system to the computerized organizer; and
displaying the first organizer information, the second organizer information, the third organizer information, and the fourth organizer information via the computerized organizer.

2. The method of claim 1, wherein the first organizer information is contact information including a name, an address, a phone number, and an e-mail address.

3. The method of claim 2, wherein the second organizer information is task information including a task description and a due date.

4. The method of claim 2, wherein the second organizer information is appointment information including an appointment description, a time, and a date.

5. The method of claim 1, wherein the first organizer information is task information including a task description and a due date.

6. The method of claim 5, wherein the second organizer information is appointment information including an appointment description, a time, and a date.

7. The method of claim 1, wherein the first organizer information is appointment information including an appointment description, a time, and a date.

8. The method of claim 1, wherein the first enterprise system is a customer relationship management system and the second enterprise system is a time-billing system.

9. The method of claim 1, wherein the first enterprise system is a document management system and the second enterprise system is a time-billing system.

10. The method of claim 1, wherein the first enterprise system is a web services based system.

11. The method of claim 1, wherein the computerized organizer is web based.

12. An apparatus for maintaining a computerized organizer, the apparatus comprising:
a processor;
a memory device operatively coupled to the processor;
a user input device operatively coupled to the processor;
a network device operatively coupled to the processor; and
a display device operatively coupled to the processor; wherein the memory device stores a software program to cause the processor to:
receive first organizer information into the computerized organizer;
receive first metadata into the computerized organizer, the first metadata indicating that the first organizer information is business type information;
store the first organizer information in a first enterprise system because the first metadata indicates that the first organizer information is business type information;
receive second organizer information into the computerized organizer;
receive second metadata into the computerized organizer, the second metadata indicating that the second organizer information is personal type information;
store the second organizer information in a non-enterprise system because the second metadata indicates that the second organizer information is personal type information;
receive third organizer information into the first enterprise system;
transmit the third organizer information from the first enterprise system to the computerized organizer;
receive fourth organizer information into a second different enterprise system;
transmit the fourth organizer information from the second enterprise system to the computerized organizer; and
display the first organizer information, the second organizer information, the third organizer information, and the fourth organizer information via the computerized organizer.

13. The apparatus of claim 12, wherein the first enterprise system is a document management system and the second enterprise system is a time-billing system.

14. The apparatus of claim 13, wherein the document management system is a first web services based system.

15. The apparatus of claim 14, wherein the time-billing system is a second different web services based system.

16. The apparatus of claim 1, wherein the computerized organizer is web based.

17. A computer readable medium storing a software program to cause a computing device executing a computerized organizer to:
receive first organizer information into the computerized organizer;
receive first metadata into the computerized organizer, the first metadata indicating that the first organizer information is business type information;
store the first organizer information in a first enterprise system because the first metadata indicates that the first organizer information is business type information;
receive second organizer information into the computerized organizer;
receive second metadata into the computerized organizer, the second metadata indicating that the second organizer information is personal type information;
store the second organizer information in a non-enterprise system because the second metadata indicates that the second organizer information is personal type information;
receive third organizer information into the first enterprise system;
transmit the third organizer information from the first enterprise system to the computerized organizer;
receive fourth organizer information into a second different enterprise system;
transmit the fourth organizer information from the second enterprise system to the computerized organizer; and
display the first organizer information, the second organizer information, the third organizer information, and the fourth organizer information via the computerized organizer.

18. The computer readable medium of claim 17, wherein the first enterprise system is a document management system and the second enterprise system is a time-billing system.

19. The apparatus of claim 18, wherein the document management system is a first web services based system.

20. The apparatus of claim 19, wherein the time-billing system is a second different web services based system.

21. The apparatus of claim 17, wherein the computerized organizer is web based.
